(19) United States
(12) Patent Application Publication
(10) Pub. No.: US 2026/0010739 A1
(43) Pub. Date: Jan. 8, 2026

(54) METHODS AND SYSTEMS FOR REAL-TIME TRANSLATION

(71) Applicant: Lucca Ventures, Inc., Southington, CT (US)

(72) Inventors: Daniel Dean Briere, Mansfield Center, CT (US); Christopher J. Allen, Sr., Stratton, VT (US); Michael Riccio, Southington, CT (US); Lucca Riccio, Southington, CT (US)

(21) Appl. No.: 18/881,787

(22) PCT Filed: Jul. 11, 2023
(86) PCT No.: PCT/US2023/027360

§ 371 Date: Jan. 7, 2025

Related U.S. Application Data
(60) Provisional application No. 63/388,215, filed on Jul. 11, 2022.

(51) Int. Cl. G06F 40/58; G10L 21/007; H04R 1/02; H04R 1/08

(52) U.S. Cl. CPC G06F 40/58; G10L 21/007; H04R 1/025; H04R 1/028; H04R 1/08; H04R 2420/07

(57) ABSTRACT

Provided for are systems and methods for real-time translation between a user and one or more participants in the conversation, the user and one or more participants speaking different languages. The user is equipped with a communications device and may have a wireless computing device, while the one or more participants advantageously are not required to be equipped with devices. Also provided for are systems and methods for real-time accent translation where a user may speak with a heavy accent or impediment, in which case other participants speaking the same language as the user may be unable to understand them. The systems and methods provide practical, real-world solutions implementing on-board, mobile, or cloud-based translation engines.

### CROSS-REFERENCE TO RELATED APPLICATIONS

This patent application is a national phase entry under 35 U.S.C. § 371 of International Application No. PCT/US2023/027360, filed Jul. 11, 2023, which claims priority to U.S. Provisional Patent Application No. 63/388,215, filed Jul. 11, 2022, each of which are incorporated by reference in their entireties herein.

### TECHNICAL FIELD

Provided for are systems and methods for real-time translation between a user and one or more participants in the conversation, the user and one or more participants speaking different languages. The user is equipped with a communications device and, may have a wireless computing device, while the one or more participants advantageously are not required to be equipped with devices. Also provided for are systems and methods for real-time accent translation where a user may speak with a heavy accent or impediment, in which case other participants speaking the same language as the user may be unable to understand the user. Certain systems and methods involve a communications device which may advantageously be attached to a mask worn by the user. The systems and methods provide practical, real-world solutions implementing device-based or cloud-based translation engines.

### BACKGROUND

While translation and other voice modulation technologies, such as those based on artificial intelligence (AI) and machine learning (ML) have advanced significantly, practical implementations of those technologies in the real world have lagged behind. For example, text-based technologies for telephonic communications have been described, such as in US Patent Publication No. US 2021/0385328 to Huawei Technologies. Certain, limited in-person translation technologies have been described for one-way translations, such as in US Patent Publication No. 2017/0060850 to Microsoft. Each of US 2021/0385328, filed Oct. 15, 2019, and 2017/0060850, filed Aug. 24, 2015, are herein incorporated by reference in their entirety.

There remains a great need for systems and methods providing real-time translation between two parties in a conversation. In one scenario, two parties may each speak different languages. If a one-way translation device were utilized, each user would need to be equipped with such a device, which would be highly unlikely in a real-world encounter such as in travel. More realistically, there is need for methods and systems utilizing a device worn only by a user which allows for translated bi-directional or multi-directional real-time translation between the user and one or more other participants in the conversation. Furthermore, the methods and systems may operate in such a manner that the one or more other participants in the conversation will hear only the user's voice and not their own translated voice, to avoid confusion. Additionally, systems and methods for real-time translation should not rely upon the other party having a mobile computing device, such as a cell phone, in order to participate in conversation. Not only is interfacing with another party's device complicating and impossible if the other party has no such device on their person, but it opens up significant data security risks particularly in international travel.

In another scenario, a user may speak with a heavy accent or impediment, in which case other participants speaking the same language as the user may be unable to understand them. There exists a need for methods and systems which modulate the user's accented or impeded speech to allow others to understand them.

In today's world, interpersonal conversations are further hampered by the need for personal protective equipment, such as face masks. Face masks not only significantly muffle speech, but also block others from viewing a person's mouth movements and facial cues, which are highly important for conversation when the speech is not sufficiently loud or clear. In some embodiments, the methods and systems disclosed herein are advantageously adapted for use with standard disposable and/or reusable face masks. In yet further embodiments, the methods and systems may utilize other headset-type devices which may be work outside of a face mask or with a face mask removed. The methods and systems described herein provide practical solutions for real-time translation in the real world, solving an existing gap in translation and/or voice modulation technologies.

### SUMMARY

In various embodiments, the present disclosure provides for devices, systems, and methods for real-time translation. In embodiments, the devices and systems include at least a communication device worn by the user. In embodiments, a wireless computing device interfaces with the communication device at least intermittently to provide one or more of firmware updates to the device, settings changes to the device, to provide additional features or functions such as GPS/location services, for accessing a cloud computer for language source files and/or translation, and/or to connect with one or more external devices such as a wireless headphone. An application running on a processor of a mobile computing device may provide these features and may additionally provide a user interface for connecting with a communication device, changing audio or translation settings, connecting with a cloud computer, etc. These and other embodiments will become clear from the following disclosure.

In an embodiment, the disclosure provides for a method for facilitating conversation between a user and another party (i.e., another individual), each speaking different languages, comprising: receiving, by a microphone of a communication device worn by a user, the spoken words from the user; generating a data signal from the spoken words; transmitting, by a wireless connection, the data signal from the communication device to a linked wireless computing device; transmitting the data signal from the wireless computing device to a cloud computer over the internet; translating the data signal to a translated data signal; transmitting the translated data signal from the cloud computer to the wireless computing device; transmitting the translated data signal from the wireless computing device to the communication device; and projecting the translated speech by a speaker of the communication device to another party.

In an embodiment, the method further comprises: receiving, by a microphone of a communication device worn by a user, the spoken response from the other party; generating a spoken response data signal from the spoken response; transmitting, by a wireless connection, the spoken response data signal from the communication device to a linked wireless computing device; transmitting the spoken response data signal from the wireless computing device to a cloud computer over the internet; translating the spoken response data signal to a translated spoken response data signal; transmitting the translated spoken response data signal from the cloud computer to the wireless computing device; and outputting audio of the translated spoken response data signal from a headphone worn by the user, wherein the headphone is connected with the wireless computing device, or optionally wherein the headphone is connected with the communication device and the audio is transmitted to the communication device prior to output by the headphone.

In further embodiments, the translated spoken response is played to the user by a headphone speaker (such as an earbud), and wherein the other party is unable to hear the translated spoken response.

In further embodiments, the method comprises the step of associating a timestamp with the data signal.

In further embodiments, the method comprises the step of evaluating a latency between the timestamp and the time of receiving the translated data signal from the cloud.

In further embodiments, the method further comprises the step of adjusting the timing of the projection of the translated speech based upon the latency, wherein the latency timing may be increased if the latency exceeds a threshold value of about 2 seconds.

In further embodiments, the latency is from about 0.5 to about 2 seconds, or less than about 10 seconds, or less than about 8 seconds, or less than about 5 seconds, or less than about 3 seconds, or less than about 2 seconds, or less than about 1 second.

In further embodiments, the other party is not equipped with any devices for facilitating conversation.

In further embodiments, the data signal is one or more of an audio file or a text file.

In further embodiments, the cloud computer performs the translation using a direct speech-to-speech translation program.

In further embodiments, the cloud computer performs the translation using a text-to-text translation program.

In an embodiment, the disclosure provides for a method of real-time accent translation, comprising: receiving, by a microphone of a communication device worn by a user, the spoken accented words from the user; generating an accented data signal from the spoken words; transmitting, by a wireless connection, the accented data signal from the communication device to a linked wireless computing device; transmitting the accented data signal from the wireless computing device to a cloud computer over the internet; correcting the data signal to an unaccented data signal; transmitting the translated data signal from the cloud computer to the wireless computing device; transmitting the translated data signal from the wireless computing device to the communication device; and projecting the translated speech by a speaker of the communication device to another party.

In further embodiments, the accented data signal is one or more of an audio file or a text file generated from the spoken accented words.

In further embodiments, the unaccented data signal is one or more of an audio file or a text file generated from correcting the data signal to the unaccented data signal.

In embodiments, provided for is a translation method wherein the communication device comprises: a headphone positioned over the ear of the user; and a module oriented proximal to the user's mouth, the module comprising a loudspeaker and one or more microphones.

In some embodiments, the user is a flexible mask wearer and wherein the communication device comprises: a microphone configured to receive speech from the mask wearer; a housing comprising a speaker configured to broadcast the speech from the mask wearer; and a first magnetic attachment component and a complementary second magnetic attachment component to magnetically secure the housing to the flexible mask; wherein the first magnetic attachment component is associated with a back of the housing and the complementary second magnetic attachment component is arranged to produce an attractive force to the first magnetic attachment component to releasably secure the back of the housing to the mask.

In some embodiments, the user is a flexible mask wearer and the communication device comprises: a microphone configured to receive speech from the mask wearer; a speaker configured to broadcast speech from the mask wearer; and a housing comprising the microphone and speaker, wherein the housing is substantially L-shaped to conform to a human chin when mounted to the flexible mask in an under-chin position.

In some embodiments, the user is a flexible mask wearer and the communication device comprises a housing comprising a microphone configured to receive speech from the mask wearer; a first magnetic attachment component and a complementary second magnetic attachment component to magnetically secure the housing to the flexible mask; and a speaker configured to broadcast the speech from the mask wearer; wherein the first magnetic attachment component is associated with a back of the housing and the complementary second magnetic attachment component is arranged to produce an attractive force to the first magnetic attachment component to releasably secure the back of the housing to the mask.

In some embodiments, wherein the user is a flexible mask wearer and the communication device comprises: a microphone configured to receive speech from the mask wearer; a speaker configured to broadcast speech from the mask wearer; a power indicator; optionally, a digital signal processor; a printed circuit board (PCB) assembly including the speaker; a power source for supplying power to the device; a device control element; a housing comprising a front housing component and a back housing component, wherein the front housing component has an opening adapted to receive a speaker cover, wherein the back housing component comprises a microphone opening for permitting speech to reach the microphone, and wherein the front and back housing components are configured to engage with each other to hold the microphone, the speaker, the power indicator, the PCB assembly, the power source, and the device control element; a first magnetic attachment component associated with the back housing a mask clip for mating with the back housing component; and a second magnetic attachment component associated with the mask clip; wherein at least one of the first and second magnetic attachment components is a magnet and the first and second magnetic attachment components are arranged to produce an attractive force and to engage the back housing component with the mask clip.

In some embodiments, the user is a flexible mask wearer and the communication device comprises: a microphone configured to receive speech from a wearer of the flexible mask; a speaker configured to broadcast the speech received by the microphone; a power source for supplying power to the device; optionally, a digital signal processor; a housing comprising a front housing component and a back housing component, wherein the front and back housing components are configured to engage with each other to hold the microphone, the speaker, and the power source; a mask clip releasably securable to the housing; a first magnetic attachment component associated with the back housing component; and a second magnetic attachment component associated with the mask clip; wherein the first and second magnetic attachment components are arranged to produce an attractive force sufficient to couple the housing to the mask clip with the flexible mask interposed therebetween.

In some embodiments, the user is a flexible mask wearer and the communication device comprises: a microphone configured to receive speech from the mask wearer; a speaker configured to broadcast speech from the mask wearer; a power indicator; optionally, a digital signal processor; a charging port; a rechargeable power source for supplying power to the device; a substantially L-shaped housing configured to conform to a human chin, the housing comprising a front housing component and a back housing component, wherein the back housing component comprises a microphone opening for permitting speech to reach the microphone, and wherein the front and back housing components are configured to be connected to hold the microphone, the speaker, the power indicator, and the rechargeable power source; and wherein the device has a total weight sufficient for attachment of the device to flexible mask for a period of at least about 30 minutes.

In some embodiments, the communication device comprises a first microphone positioned to capture the users spoken words and a second microphone positioned to capture the spoken words of the other party.

In embodiments, the disclosure provides for a system for facilitating conversation between a user and another party (i.e., another individual), each speaking different languages, comprising: a communication device worn by a user, the communication device comprising: a microphone to receive speech from the user in a first language; a speaker to project translated speech into a second language; a headphone speaker (earbud) to project translated speech from another party in the second language to the user in the first language; optionally, a digital signal processor; a wireless circuit assembly; and a power source; wireless computing device wirelessly linked to the communication device; optionally, a cloud computer connected with the wireless computing device over the internet; a translation program running on the communication device, wireless computing device, or cloud computer to translate spoken words of the user, in the first language, to the second language in real time; and language source code stored on one or more of the communication device, wireless computing device, or cloud computer.

In some embodiments, the system further comprises a latency evaluation logic running on a processor of the wireless computing device (or alternatively running on a processor of the communication device).

In some embodiments, the latency evaluation logic determines the duration of time for the translated speech to be received by the wireless computing device.

In some embodiments, the system further comprises a conversational cadence logic to adjust a timing at which the translated speech in the second language is projected.

In some embodiments, the communication device comprises: a headphone positioned over the ear of the user; and a module oriented proximal to the user's mouth, the module comprising a loudspeaker and one or more microphones.

In some embodiments, the user is a flexible mask wearer and wherein the communication device comprises: a microphone configured to receive speech from the mask wearer; a housing comprising a speaker configured to broadcast the speech from the mask wearer; and a first magnetic attachment component and a complementary second magnetic attachment component to magnetically secure the housing to the flexible mask; wherein the first magnetic attachment component is associated with a back of the housing and the complementary second magnetic attachment component is arranged to produce an attractive force to the first magnetic attachment component to releasably secure the back of the housing to the mask.

In some embodiments, the user is a flexible mask wearer and the communication device comprises: a microphone configured to receive speech from the mask wearer; a speaker configured to broadcast speech from the mask wearer; and a housing comprising the microphone and speaker, wherein the housing is substantially L-shaped to conform to a human chin when mounted to the flexible mask in an under-chin position.

In some embodiments, the user is a flexible mask wearer and the communication device comprises a housing comprising a microphone configured to receive speech from the mask wearer; a first magnetic attachment component and a complementary second magnetic attachment component to magnetically secure the housing to the flexible mask; and a speaker configured to broadcast the speech from the mask wearer; wherein the first magnetic attachment component is associated with a back of the housing and the complementary second magnetic attachment component is arranged to produce an attractive force to the first magnetic attachment component to releasably secure the back of the housing to the mask.

In some embodiments, wherein the user is a flexible mask wearer and the communication device comprises: a microphone configured to receive speech from the mask wearer; a speaker configured to broadcast speech from the mask wearer; a power indicator; optionally, a digital signal processor; a printed circuit board (PCB) assembly including the speaker; a power source for supplying power to the device; a device control element; a housing comprising a front housing component and a back housing component, wherein the front housing component has an opening adapted to receive a speaker cover, wherein the back housing component comprises a microphone opening for permitting speech to reach the microphone, and wherein the front and back housing components are configured to engage with each other to hold the microphone, the speaker, the power indicator, the PCB assembly, the power source, and the device control element; a first magnetic attachment component associated with the back housing a mask clip for mating with the back housing component; and a second magnetic attachment component associated with the mask clip; wherein at least one of the first and second magnetic attachment components is a magnet and the first and second magnetic attachment components are arranged to produce an attractive force and to engage the back housing component with the mask clip.

In some embodiments, the user is a flexible mask wearer and the communication device comprises: a microphone configured to receive speech from a wearer of the flexible mask; a speaker configured to broadcast the speech received by the microphone; a power source for supplying power to the device; optionally, a digital signal processor; a housing comprising a front housing component and a back housing component, wherein the front and back housing components are configured to engage with each other to hold the microphone, the speaker, and the power source; a mask clip releasably securable to the housing; a first magnetic attachment component associated with the back housing component; and a second magnetic attachment component associated with the mask clip; wherein the first and second magnetic attachment components are arranged to produce an attractive force sufficient to couple the housing to the mask clip with the flexible mask interposed therebetween.

In some embodiments, the user is a flexible mask wearer and the communication device comprises: a microphone configured to receive speech from the mask wearer; a speaker configured to broadcast speech from the mask wearer; a power indicator; optionally, a digital signal processor; a charging port; a rechargeable power source for supplying power to the device; a substantially L-shaped housing configured to conform to a human chin, the housing comprising a front housing component and a back housing component, wherein the back housing component comprises a microphone opening for permitting speech to reach the microphone, and wherein the front and back housing components are configured to be connected to hold the microphone, the speaker, the power indicator, and the rechargeable power source; and wherein the device has a total weight sufficient for attachment of the device to flexible mask for a period of at least about 30 minutes.

In embodiments, the disclosure provides for a system for real-time accent translation, comprising: a communication device worn by a user (for example, any listed above), the communication device comprising: a microphone to receive accented speech from the user; a speaker to project translated (corrected) speech with accent correction; a wireless circuit assembly; and a power source; a wireless computing device wirelessly linked to the communication device; a cloud computer connected with the wireless computing device over the internet; and a translation program running on the cloud computer to perform the accent correction.

In embodiments, the disclosure provides for a method for facilitating conversation between a user and another party (i.e., another individual), each speaking different languages, comprising: receiving, by a microphone of a communication device worn by a user, the spoken words from the user; generating a data signal from the spoken words; translating the data signal to a translated data signal by one of the communication device, a wirelessly linked wireless computing device, or a cloud computer connected to the wireless computing device over the internet; and projecting the translated speech by a speaker of the communication device to another party, 1) wherein the translation is performed on the communication device if a language source file is stored on a data store thereof, and if not, is performed on the wireless computing device or cloud computer, wherein the cloud computer is utilized for translation if the language source file is not stored on a data store of the wireless computing device or the data store of the communication device, or 2) wherein the translation is performed on the communication device or the wireless computing device and wherein, if the language source file is not present on a data store of the communication device or a data store of the wireless computing device, the language source file is downloaded from a cloud computer and stored on a data store or flash memory of the communication device or wireless computing device, either of which may be configured for translation.

### BRIEF DESCRIPTION OF THE DRAWINGS

FIG. 1A depicts an exemplary embodiment of real-time language translation using a cloud-based translation engine;

FIG. 1B depicts an exemplary embodiment of real-time translation using a translation engine on a communication device or wireless computing device;

FIG. 1C depicts an exemplary method of translation of user speech to a language of another party using a cloud-based translation engine;

FIG. 1D depicts an exemplary method of translation of speech of another party to the user's language using a cloud-based translation engine;

FIG. 1E depicts an exemplary method of translation of user speech to a language of another party on a communication device;

FIG. 1F depicts an exemplary method of translation of speech of another party to the user's language on a communication device;

FIG. 1G depicts an exemplary method of translation of user speech to a language of another party on a wireless computing device;

FIG. 1H depicts an exemplary method of translation of speech of another party to the user's language on a wireless computing device;

FIG. 2 depicts an exemplary embodiment of real-time language translation between an English-speaking user and a Ukranian-speaking participant in the conversation, where the User is wearing a standard face mask and communication device releasably attached to the face mask;

FIG. 3 depicts an exemplary embodiment of real-time language translation between an English-speaking user and a Ukranian-speaking participant in the conversation, where the User is wearing a headset-type communication device;

FIG. 4 depicts an exemplary embodiment of real-time language translation;

FIG. 5 depicts an exemplary embodiment of real-time accent translation;

FIG. 6 depicts an exemplary embodiment of a headset-type communication device;

FIG. 7 depicts an exemplary embodiment of a communication device for releasable magnetic attachment to a face mask, the device having a microphone module inside the mask and a speaker module outside the mask;

FIG. 8 depicts an exemplary embodiment of a communication device for releasable magnetic attachment to a face mask, the device having a microphone module inside the mask and a speaker module outside the mask;

FIG. 9 depicts an exemplary embodiment of a communication device for releasable magnetic attachment to a face mask, the device having a microphone module magnetically attachable to the mask with a wired connection to a speaker module;

FIG. 10 depicts an exemplary embodiment of a communication device for releasable magnetic attachment to a face mask, the device having a microphone module magnetically attachable to the mask with a wired connection to a speaker module;

FIG. 11 depicts an exemplary embodiment of a communication device for releasable magnetic attachment to a face mask, the device having a microphone and speaker located in a housing on the mask;

FIG. 11 depicts an exemplary embodiment of a communication device for releasable magnetic attachment to a face mask, the device having a microphone and speaker located in a housing on the mask exterior and a mask clip on the mask interior for magnetic securement to the mask;

FIG. 13 depicts an exemplary embodiment of a communication device for releasable magnetic attachment to a face mask, the device having a microphone and speaker located in a housing on the mask;

FIG. 14 depicts an exemplary embodiment of a communication device for releasable magnetic attachment to a face mask, the device having a microphone on the back and a loudspeaker on the front, the device having Bluetooth for wireless communications;

FIG. 15 depicts an exemplary embodiment of a communication device for releasable magnetic attachment to a face mask, the device having a microphone and speaker located in a housing and being attachable to a mask by sandwiching the mask between the housing and mask clip.

FIG. 16 depicts an exploded perspective view of an exemplary embodiment of a communication device for releasable magnetic attachment to a face mask;

FIG. 17 depicts an exemplary embodiment of an L-shaped communication device for releasable magnetic attachment to a face mask;

FIG. 18 depicts an exploded perspective view of an exemplary embodiment of an L-shaped communication device for releasable magnetic attachment to a face mask; and

FIG. 19 depicts an exemplary embodiment of a communication device with two microphones, one positioned for picking up the user's voice and another positioned for picking up the voice of another party.

FIG. 20 depicts an exemplary embodiment of real-time language translation with a communication device having a module in wired connection with a mask-associated microphone;

### DETAILED DESCRIPTION

The disclosure generally relates to systems and methods for real-time translation between a user and one or more participants in the conversation. The user is equipped with a communications device and may have a wireless computing device, while the one or more participants advantageously are not required to be equipped with any devices. The user will generally be proficient in a first spoken language which the one or more participants may not understand. The one or more participants may be proficient in a second spoken language which the user does not understand. The systems and methods herein provide for real-time translation such that the parties (i.e., the user and the one or more participants) may communicate in spoken words via in real-time with minimal or optimized latency. In yet further embodiments, a user may speak with a heavy accent or impediment, in which case other participants speaking the same language as the user may be unable to understand them. The present disclosure further provides for methods and systems which modulate the user's accented or impeded speech to allow others to understand them.

### Real-Time Translation

The systems and methods for real-time translation described herein utilize a communications device worn by a user to facilitate communication with a participant. Generally, the participants are not required to be equipped with any devices or do not need to directly interact with any device in order to hold a spoken conversation with the user. This is particularly advantageous because it is highly unlikely that two parties needing to communicate would each be wearing translation equipment in various scenarios including travel, business, and other scenarios.

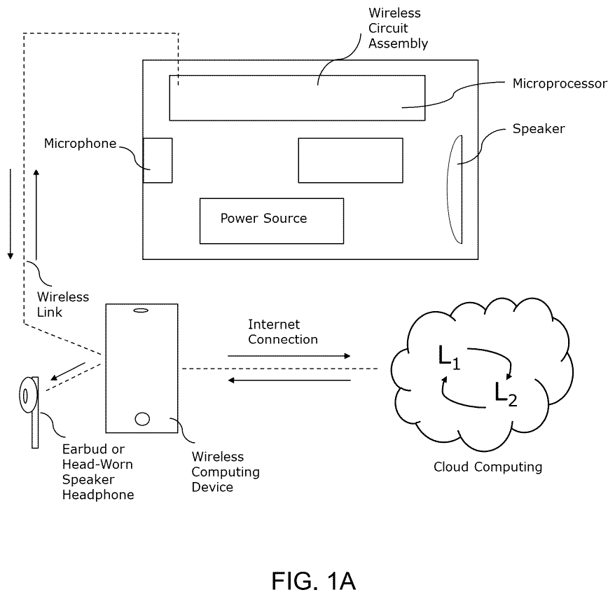

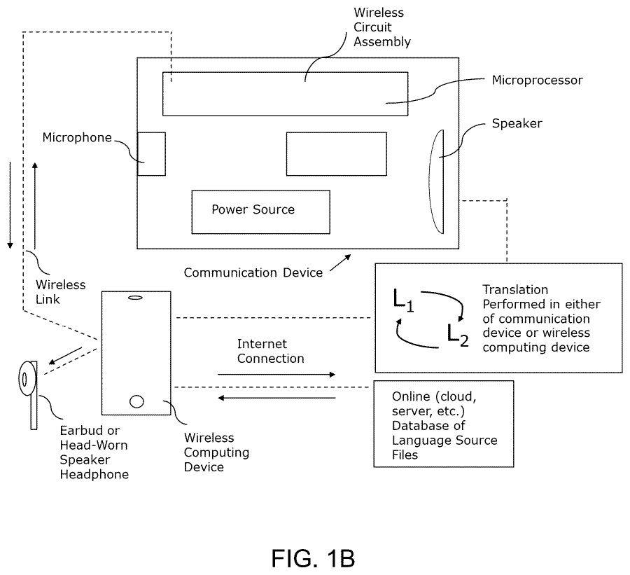

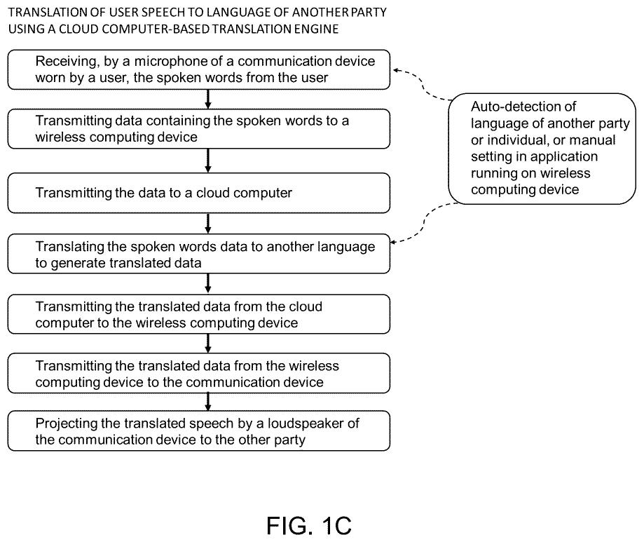

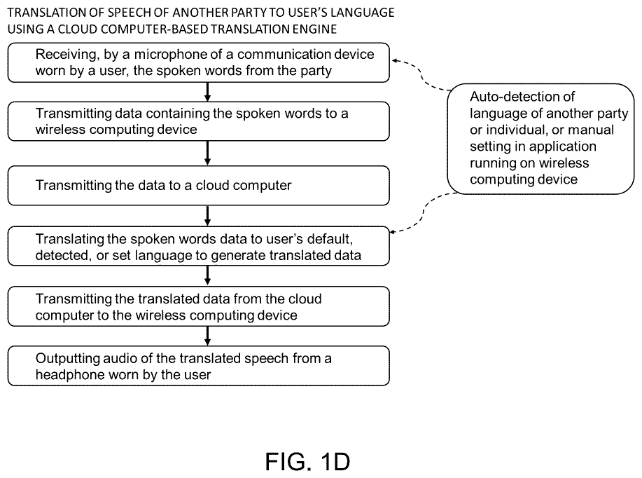

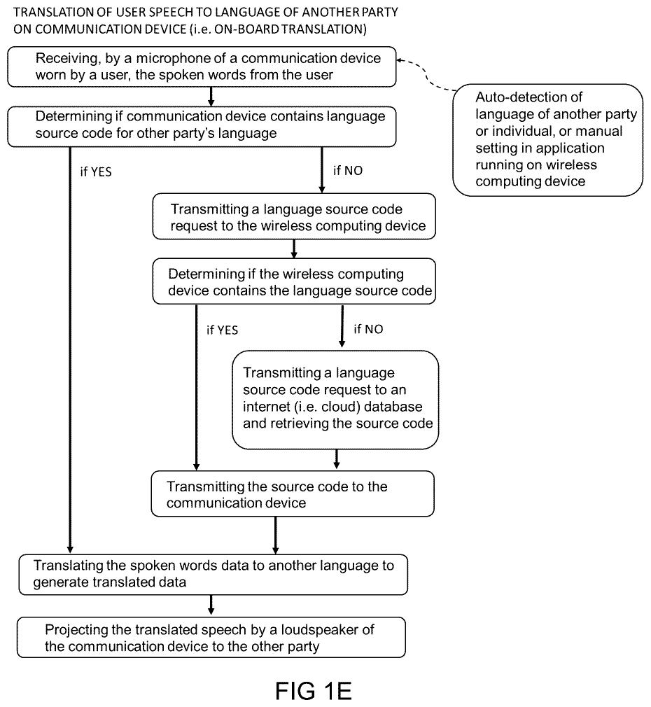

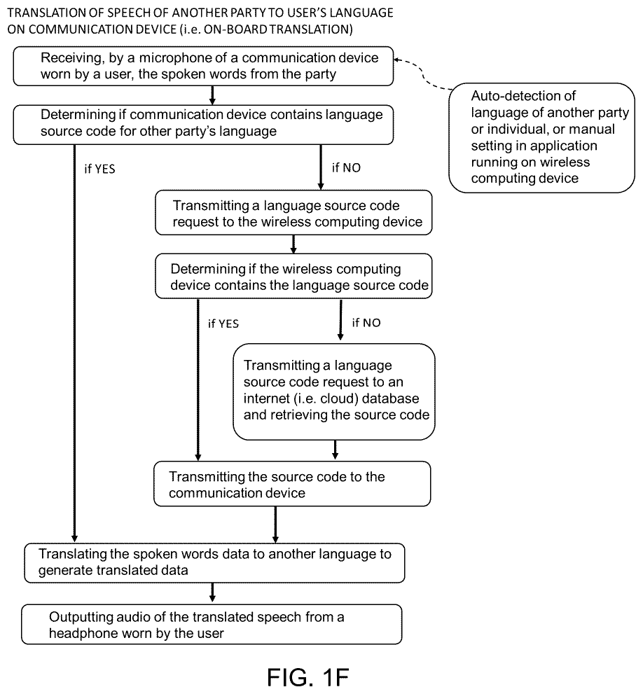

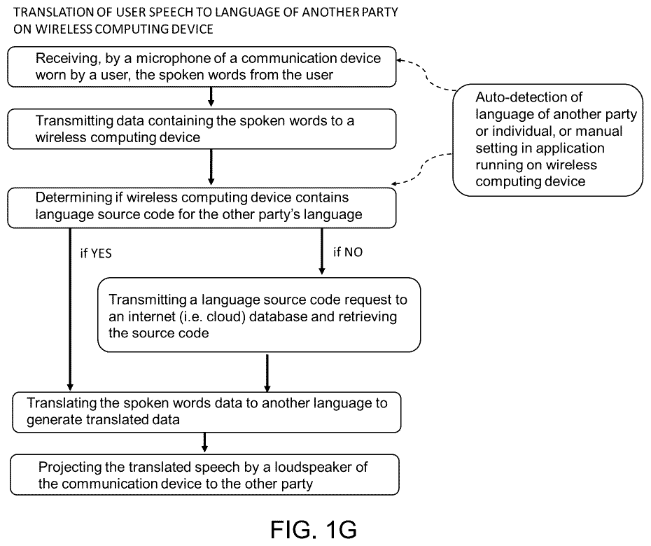

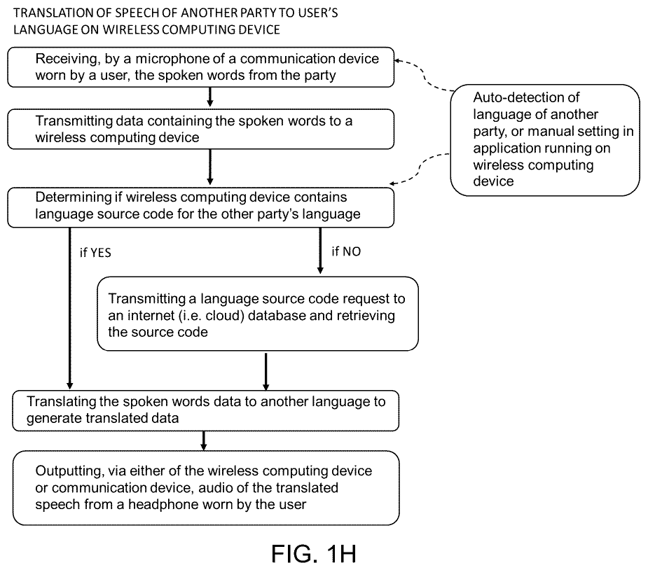

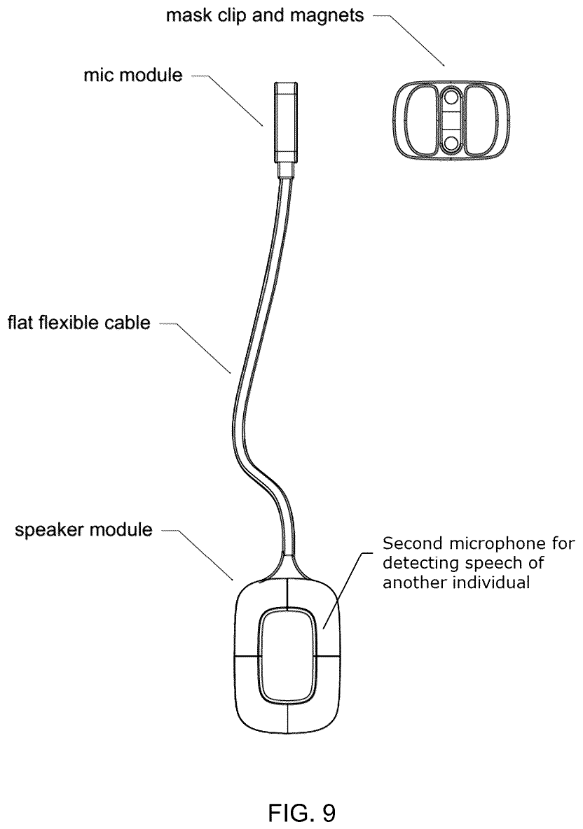

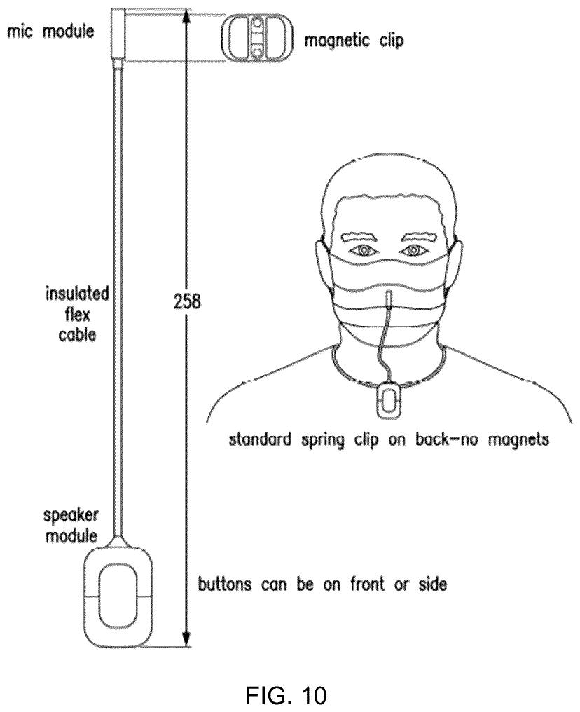

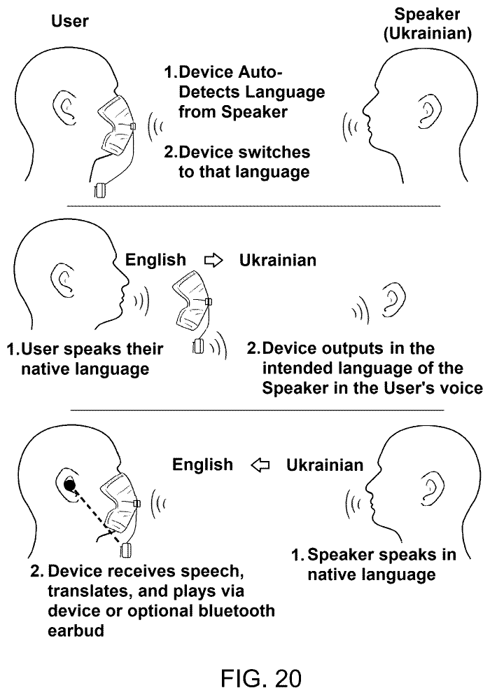

The user is generally equipped with at least a communication device and may have a wireless computing device, such as a smartphone (cellular phone), tablet, computer, or other portable electronic device having one or more wireless capabilities including, but not limited to, WiFi, Bluetooth, Cellular data (5G LTE,4G LTE, 5G, 4G, etc.). As shown in FIG. 1A, the communication device worn by the user generally communicates with the wireless computing device by a wireless communication link, such as Bluetooth. The communication between the communication device and the wireless computing device, and between the wireless computing device and the cloud computer, may be intermittent, periodic, or continuous in various embodiments. The wireless computing device is connected to the cloud, directly or by way of a wireless computing device, by an internet connection for language translation or alternatively for downloading language source files necessary for translation at the wireless computing device. The cloud may be used to store other files, translation or conversation archives, user account information such as preferences, language information, or other useful information. In the exemplary embodiment of FIG. 1A, the communication device is shown having a microphone and speaker in a single device. However, in alternative embodiments, the microphone and speaker may be housed in separate housings with the other components contained within either of the microphone or speaker housings. For example, the microphone may be contained within a housing separate from the other components housed in a separate module (as depicted in FIGS. 9, 10, and 20) and the microphone may be in wired or wireless connection with the module. In alternative embodiments, the speaker may be separate from the other components and may be in wired or wireless connection with a module housing the other components. These same communication device features are applicable to the exemplary embodiments of FIG. 1B.

The user is also generally equipped with one or more earbuds, head-worn speaker headphones, or some other local means to playback the translated speech from other participants in the conversation selectively to the ear(s) of the user, as shown in FIG. 1A. The earbud is connected to the communication device or wireless computing device wirelessly, such as by Bluetooth, and plays back the translated speech of other conversation participants to the user. This is particularly advantageous because the conversation will be perceived as more normal to other participants if they do not hear their own voice played back as a translation on a loudspeaker. In this manner, the user, who is accustomed to utilizing the devices, methods, and systems, will be able to interact with individuals having no prior training or knowledge of such devices, methods and systems. Playback of the other participants' translations on a loudspeaker would be a significant disadvantage. Even so, the present methods and systems would be capable of functioning without an earbud or headphone, for instance, if the user misplaces them or if the earbud is wireless and runs out of battery. In these cases, the loudspeaker could play back both the user's translated voice and other participant's translated voices.

Cloud-based language translation technologies are known and any suitable technologies may be utilized in the present disclosure, as would be understood by a person of skill in the art. For example, Google Cloud Translation utilizing AI (artificial intelligence) or ML (machine learning) may be utilized. Amazon Translate neural machine translation is another exemplary technology, as well as Microsoft Translator. Such technologies may rely upon speech-to-text, optional speech corrections, machine translation of text, and then text to speech. Alternative technologies such as Google AI's Translatotron offer direct speech-to-speech translation without intervening text workflow and which may also preserve aspects of the user's voice. Other technologies, for example including Amazon Alexa, may use training data to reproduce certain voices, and such technologies may be applied to reproduce the user's voice or to modify the user's voice for practical or entertainment purposes (such as a celebrity voice, etc.). Additional technologies such as Meta's universal speech translator (UST) may allow for translation of even language which are not predominantly written, allowing for the systems and methods of the present disclosure to be used in conversation with other parties speaking more obscure languages and/or dialects. Generally, any suitable translation technology is contemplated. As illustrated in FIG. 1A, translations between L1 (a first language) and L2 (a second language) may be achieved.

Known language translation technologies may also be compiled or incorporated into locally-run translation programs on the wireless computing device or on the communication device. In such embodiments, for example as shown in FIGS. 1B and 1E-1H, the communication device or wireless computing device may be pre-loaded with language source files for a certain language or, alternatively, may download or retrieve language source files from an internet-accessible database such as a cloud storage server. The communication device or wireless computing device may, in connection with the user's default settings, be pre-loaded with the language source file for the user's language. It is also contemplated that the communication device may be configured to locally run language translation programs. Communication devices may be configured with WiFi or cellular data connectivity in order to directly download language source data from an internet or cloud database if the language source files are not locally stored. As an example, in advance of international travel, a user may pre-load necessary language source files to one or more of the communication device and the wireless computing device in order to be prepared to utilize real-time language translation even if the device(s) cannot access the internet. Each of the communication device and wireless computing device may have a data store for long-term (i.e., non-transitory) storage of necessary language source files and/or flash memory for temporary storage of language source files. Locally-run and cloud-based translations may be used alternatively or together, depending upon factors such as monitored latency of cloud-based translation, manual user settings, internet speed or connection strength, or other factors.

Certain embodiments where cloud-based translation is utilized would not require any pre-downloaded or accessed source code because cloud servers would have the necessary programming to perform the translation(s). Additionally, systems and methods relying upon direct language translation by AI may not require source code at all where the AI is trained to automatically translate the speech of the user or other party. In some embodiments, AI programs may be located on one or more of the mobile computing device and cloud computer. In alternative embodiments, AI translation programs may be located on the user communication device. In yet further embodiments, AI translation programs may be located on two or more of the communication device, mobile computing device, or cloud computer and may be utilized as necessary. For example, a longer portion of a spoken conversation having many words may take significantly more computing resources than a shorter portion of a spoken conversation having few words. The devices, systems, and methods may balance the trade-offs between relative computing power (communication device vs. mobile computing device vs. cloud computer) and latency due to internet communications in order to maximize the computational efficiency, speed, and accuracy of the translation.

In an embodiment, location data from the GPS of the mobile computing device is used to predict likely languages that the user will encounter based upon the diversity of language in the region where the user is located. For example, if the user is located in Germany, the mobile computing device may utilize its location services to set the language of another party to German. If language source code is involved, the mobile computing device may automatically retrieve the language source code during a period of internet access if the translation is to be performed on the mobile computing device. If cloud translation will be used, the mobile computing device may send an indication of the user's location to the cloud computer to instruct the cloud computer to set the other party language default to German. However, if the user encounters a person speaking a different language, the mobile computing device and/or cloud computer may auto-detect the language and select a language other than the default in order to provide translated speech with the other party. If the user is in a country or region having more than one predominant language (e.g. Belgium, which has Dutch, French, and German), then more than one language may be a default or expected language based upon the location services of the mobile computing device GPS.

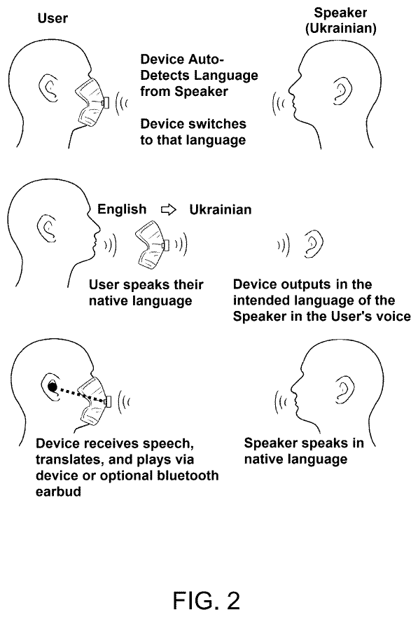

The real-time translation allows for fluid support for in-language discussion. A general scheme is shown in FIG. 2. In the depicted scenario, the user is equipped with a communication device. In this exemplary embodiment, the communication device is releasably or permanently attached to a protective face mask. The communication device is generally wirelessly linked to the user's smart phone or other wireless computing device. If the user wishes to engage in a conversation, the user may activate the translation capability by using a wake word, by pressing a button on the device, or by utilizing an application running on the linked wireless computing device. Alternatively, the communication device may be in an always on mode to translate spoken language from other persons for the user to hear without the user speaking.

The communication device may be set to the user's spoken language by default or may auto-detect the spoken language of the user. In cases where the user is bilingual or multilingual, the communication device may adaptively change between language settings. Alternatively, the device does not require any language settings and the language is auto-detected in the voice data sent to and translated in the cloud or, alternatively, locally in the wireless computing device or in the communication device.

Once the device is activated, the device may, in some embodiments, auto-detect the speech of a participant (i.e., a speaker as shown in FIG. 2) and switch to that language. For instance, the device may be set to English for the user, and the device may auto-detect that the other participant is speaking in Ukranian. This detection may be performed by one or more of the device, the wireless computing device, or the cloud.

As an example, as shown in FIG. 2, the user may speak in their native language of English. The spoken words of the user are picked up by the microphone of the communication device as a speech signal which is wirelessly transmitted to the wireless computing device which in turn transmits the signal to the cloud. In alternative embodiments, speech to text translation is performed on one or more of the communication device or wireless computing device, and translated text data is transmitted to the cloud. Cloud computing is then used to translate the first language (English) to the second language (Ukrainian). The translated language is transmitted (in the form of text or a playable audio signal) from the cloud to the wireless computing device, and from the wireless computing device back to the communication device. The communication device then projects the translated language to the participant via a speaker or loudspeaker.

In various embodiments, the systems and methods of the present disclosure translate one or more of a user's speech and another parties' speech while maintaining one or more aspects of the respective individuals' speech. In an embodiment, speech is transcribed to text, the text is translated, and translated speech is generated from the translated text. In an embodiment, one or more aspects of an individual's speech is maintained in the translated speech to produce “natural translated speech”. Maintaining one or more aspects of an individual's speech is performed so that the output translated speech sounds closer to the speech of the person speaking rather than a generic, machine-generated voice. For example, one or more of fundamental speech sounds (such as “oo” in book or look, “ee” in leek, beach or sea, etc.), vowel emphasis, consonant emphasis, speech speed, volume variation, timing between sentences, pitch, and tone may be processed and maintained in the translated speech. These and other “speech aspects” may be used in the systems and methods herein.

Speech aspects may be pre-determined or uniquely determined for each translation, or combinations thereof. For example, the user may use a device or system frequently or repeatedly, and it may be advantageous to save a pre-determined analysis of speech aspects of the user's speech. In an embodiment, the pre-determined analysis is performed in a training mode. In a training mode, a user may read prompts which are designed to emphasize the speech aspects to be analyzed. In an alternative training mode, a user may speak any collection of words or phrases and proof-read generated text to ensure that the correct terms are being analyzed. This speech aspect training may be run simultaneously or in parallel with voice recognition training which improves the accuracy of translation of the users speech. If the user is fluent or at least conversant in another language beyond their main language, training may additionally be performed in a second or additional language(s) in order to more fully capture the user's speech aspects.

Certain embodiments employ direct speech-to-speech translation without intervening text, such as certain AI translation embodiments. In such embodiments, the AI may analyze one or more speech aspects, or may be provided with an analysis of speech aspects as described herein, such as a training mode analysis. AI embodiments may perform iterative analysis in a training mode to optimize the generated translation against a user's speech. The speech aspects are generally applied to generate natural translated speech for the individual.

With respect to an individual other than the user, in an embodiment, the other individual's speech is not analyzed for speech aspects. In an embodiment, the other individual's speech is analyzed for speech aspects and natural translated speech is played back to the user. In an embodiment, the one or more speech aspects are analyzed to associate a unique identifier to other individuals that the user encounters. In this manner, for example, individual 0005 may have associated speech aspects which differ from individual 0236's speech aspects. In this manner, natural speech translations may be improved or determined for unique individuals with which the user interacts frequently. The other individual's speech may be analyzed in whole, or in parts where certain speech aspects of interest are detected. Speech aspects of one or more of the user or other unique individuals may be stored in a data store of one or more of a communication device, mobile computing device, or cloud computer, for retrieval and use in generating natural language translations. In this manner, the user may have a more engaging conversation with another individual compared to machine-generated translations.

One or more speech aspects may also be used in embodiments including accent translation, with the exception that certain speech aspects, such as speech sounds, vowel emphasis, consonant emphasis, etc., may be modified in accordance with phonetic characteristics of a given, desired accent. In various embodiments, accent source code may contain phonetic characteristics of various accents. In some embodiments, accent source code includes a library of words and their phonetic characteristics in a first accent, and a library of words and their phonetic characteristics in a second accent. In an embodiment, phonetic characteristics of an individual's speech are analyzed to determine a closest first accent, and the first accent is translated to the second accent. In an embodiment, the individual (if the user) may manually set their accent in accordance with a pre-determined library of accents. In an embodiment, the systems may auto-detect the accent of the user. In yet further embodiments, the user may manually select a desired accent, the desired accent may be set in accordance with GPS location services of a connected mobile computing device, or the desired accent may be auto-detected from speech of another individual. In yet further embodiments, AI may be used to detect accent of the user and other party. In yet further embodiments, AI may be implemented to perform direct accent to accent translation.

Generally, several operating principles are contemplated as independent embodiments which may be performed alternatively or in combination. In an embodiment, only audio data or data containing audio of spoken words is transmitted between devices. For example, the communication device may transmit audio data to the wireless computing device which may perform the translation, or may alternatively transmit the audio data to a cloud computer for translation. On the wireless computing device, or on the cloud computer, the translation may be performed as speech-to-text-to-speech translation, where an audio file of machine-generated speech is then transmitted back to the wireless computing device and, in turn, to the communication device or headphone speaker for playback. In alternative embodiments, a text file or file containing or encoding the text may be transmitted. For example, the communication device or the wireless computing device may transmit an audio file to a cloud computer, which may return a translated text transcript. The translated text may then be converted to machine-generated audio by one or more of the wireless computing device or communication device. Likewise, it is contemplated that the wireless computing device may perform speech-to-text-to-speech translation and may transmit either of a translated audio file of machine-generated speech or a text file to the communication device for generation of machine-generated speech. In yet further embodiments employing direct speech-to-speech translation, no text files are generated and only audio files are transmitted, as necessary. It can be appreciated that any useful operating principles are contemplated.

In the course of a normal conversation, the user may speak to the participant, and then the participant may choose to respond to the user. Once the participant has heard and understood the translated speech from the user, the participant may then speak in their native language (e.g. Ukrainian). The speech from the participant is then picked up by a microphone on the communication device. In some embodiments, the communication device has a single microphone which is used to pick up speech from both the user and from the other participant. In some embodiments, the communication device has two microphones, one for picking up speech from the user and one for picking up speech from the other participant. In some embodiments, the communication device may utilizer more than one microphone for each purpose, for example, for noise cancellation or for the removal of environmental noise.

Once the speech from the participant is picked up, the participant's speech may be translated as described herein using onboard processing, wireless computing device-based processing, or cloud computing, and then the translated speech (Ukranian to English) is received by the communication device. The translated speech from the participant may then be played back for the user to hear. In some embodiments, the playback is from the same loudspeaker used to project the user's voice. In preferred embodiments, the communication device may have an additional speaker to project the translated speech from the participant toward the user. In alternative embodiments, the user may be wearing one or more wireless earbuds (e.g., Apple Airpods or Google Pixel Buds) which are connected to the wireless computing device via Bluetooth or another suitable protocol allowing for multiple device connections. The translated speech may then be played back to the user through the headphones and not through a loudspeaker. The use of an earbud or headphones is advantageous because the participant speaking will not be interrupted by their own translated speech while they are speaking and the conversation will be more fluid.

In some cases, where there is a potential misunderstanding or difficulty in understanding the translation, the user may choose to display text of their translated speech to show to the other participant, or text of the other participant's translated speech to themselves. This display may be performed on the wireless computing device through an application running on a processor thereof. The text may be automatically transferred to the device or the application may execute a command to retrieve the text from the communication device or the cloud computer, depending upon where the translation was performed. In cases of direct speech-to-speech translation where no text was previously generated, the wireless computing device may further generate a text transcript of the translation.

The systems and methods herein achieve real-time translation by having minimal latency. Systems and methods utilizing on-board language translation by the communication device or the wireless computing device will typically have negligible or relatively small latency. For embodiments which utilize cloud-based translation engines, there is typically larger latency relative to on-board embodiments, and the systems and methods utilizing cloud-based translation engines will generally achieve minimal latency. This means that the delay between spoken words and projected translation is minimal, such as about 0.5 to 2 seconds. Depending upon the exact circumstances, different minimal latency ranges may be preferable, including but not limited to about 0.25 seconds to about 8 seconds, or about 0.25 seconds to about 5 seconds, or about 0.25 seconds to about 3 seconds. The latency may be less than about 30 seconds, or less than about 10 seconds, or less than about 8 seconds, or less than about 5 seconds, or less than about 3 seconds, or less than about 2 seconds, or less than about 1 second. In some embodiments, such as if the internet connection to the cloud is slow or unstable, a larger latency may be tolerated. In certain embodiments, such as when the internet connection is slow or unstable, the latency may be defaulted to a larger value (e.g., 5 seconds) to ensure that the conversation cadence is not varying.

That is, in some embodiments, the systems and methods of the present disclosure may determine a latency of the time required for the device to receive the translated speech for playback. The latency may be variable or difficult to predict due to variations in internet speed or, in some cases, unpredictable variations in AI translation speed. Because of these unpredictable factors, the systems and methods may need to continuously or periodically monitor latency to ensure fluid conversation can be maintained.

In order to further maintain conversational cadence based upon the detected latency, each audio signal may be associated with a timestamp by either the communication device or the wireless computing device. A first timestamp may be the time at which the speech detected by the microphone is first sent to the mobile computing device or cloud computer. A second timestamp may be at the time the translated speech is received by the mobile computing device. The timestamps may be used to evaluate latency from the translation returned from the cloud and/or may be used to adjust the playback timing of the translation. This feature is advantageous in real-time conversation because it is difficult to hold a prolonged conversation when the playback timing is largely variable or unpredictable. For example, if the timestamps show an average latency of less than a certain threshold value (e.g., 2 seconds), then the conversational cadence may not require adjustments. If the latency is larger or is variable, then the system may adjust playback timing in order to maintain the conversational cadence.

For example, if some translations are arriving within 2 seconds while others are taking up to 10 seconds, the variation in delay between 2 to 10 seconds may make conversation awkward or difficult. In such cases, the translations arriving faster may be delayed in their playback to a time closer to 10 seconds (such as 8 seconds, for example), or to 10 seconds, such that a regular conversational cadence is maintained. In an embodiment, the systems and methods may delay playback to some proportion of a detected or calculated maximum latency value. In an embodiment, the systems and methods may delay playback to 70%, 75%, 80%, 85%, 90%, 95%, or 100% of a maximum latency value. For example, where the systems and methods delay playback to 80% of a maximum latency value of 10 seconds, a threshold value of 8 seconds would be established. Any translations arriving in faster than 8 seconds would have their playback delayed to 8 seconds whereas any translations arriving later than 8 seconds would be played back immediately. In this manner, a conversational cadence can be maintained to more closely mimic natural communication.

These conversational cadence and latency features may be provided by a latency evaluation logic running on a processor of one or more of the communication device or the wireless computing device. This feature is important for maintaining fluid conversation in real-world applications where internet connection speeds can vary in crowded areas, rural settings, etc. Additionally, some AI translation technologies may have somewhat unpredictable processing times and latency evaluation for conversational cadence solves this issue with respect to utilizing these technologies in real-time conversation.

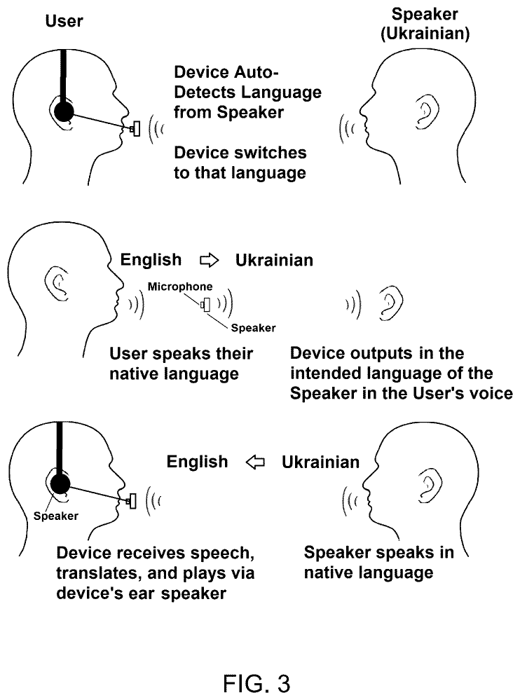

While advantageous, it is not required that the communication device is releasably attachable to a protective face mask. In alternative embodiments (FIG. 3, for example), a headset device may be utilized which has a microphone/speaker assembly placed in front of the user's mouth, and an additional speaker positioned over the user's ear. The headset device may comprise one or more microphones such that at least one microphone is positioned for picking up the speech of the user and at least one microphone is positioned for picking up the speech of another party. It can be appreciated that such headset devices differ from a standard headset because the headset devices have a loudspeaker positioned substantially oriented to project audio away from the user, optionally being located by the mouth of the user, to project translated speech to another party.

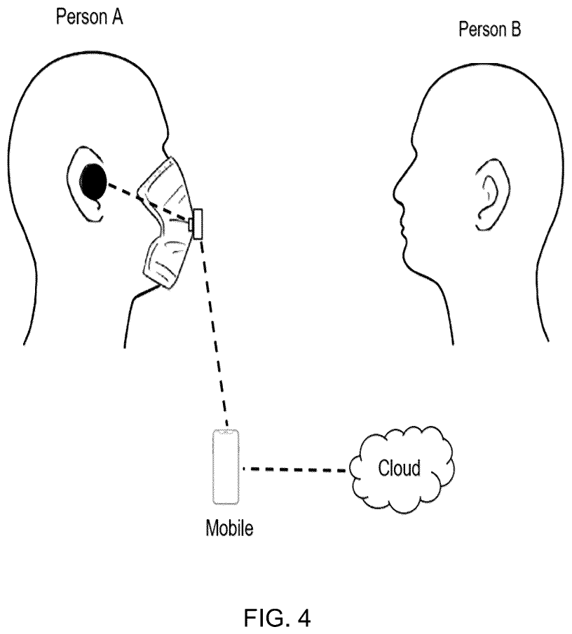

In embodiments such as those depicted in FIG. 4, a user (Person A) is equipped with at least a mask-worn communication device. The communication device may be connected with a mobile computing device and cloud as described herein. If the user approaches another person (Person B) speaking a different language (e.g. Ukrainian), the device can be used to facilitate real-time translation. For example, Person B might first speak in Ukrainian. The communication device, by one of its microphones, receives the Ukrainian speech and, either via onboard processor, mobile computing device mobile application, or cloud, processes the speech. In the depicted embodiment, a microphone facing outwardly from the mask will be used to pick up the speech of Person B, while a second user microphone located inside the mask or facing the mask will be used to pick up user speech. In accordance with a pre-defined setting or in accordance with auto-detection, the system may recognize the Person B speech as Ukrainian. The Ukrainian speech is translated as described herein to the user's language (e.g. English) and played back to the user by a headphone speaker. The user may respond by speaking in English and their speech will be picked up by the user microphone. Their speech is then translated, either via onboard processor, mobile computing device mobile application, or cloud, to Ukrainian. The translated speech is then projected over a loudspeaker on the communication device. While not as preferable, it is additionally contemplated that translated speech may be transmitted to a device on Person B's person. After hearing the speech over the loudspeaker, person B may then respond, and the conversation continues naturally with Person B advantageously hearing only the muffled user speech through the mask (in, e.g., English) and the amplified loudspeaker-projected translated speech (in, e.g., Ukranian).

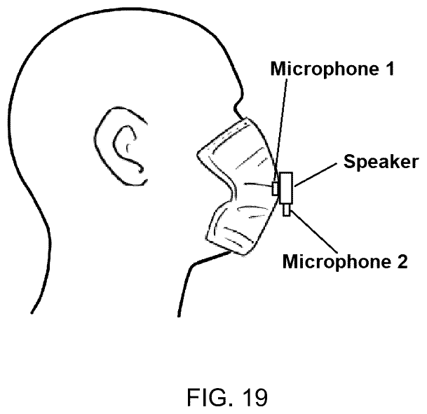

In exemplary embodiments, such the embodiment depicted in FIG. 19, the communication device may have two microphones-one for picking up the user's voice and another for picking up the voice of another party or individual. The microphones may be positioned such that the user microphone is oriented substantially toward the mouth of the user and that the other microphone is oriented substantially away from the mouth of the user. In some embodiments including a face mask, the user microphone may be positioned inside of the face mask or, alternatively, adjacent to the mask material on the outside of the mask. It is contemplated that additional microphones may be incorporated for capturing speech from other directions around the user, or for capturing environmental noise for the purposes of noise reduction.

An application running on a process of the wireless computing device may control one or more aspects of the system. The application may perform one or more functions such as searching for wireless devices (including communication devices, headphone speaker or earbud devices, etc.) in range, connecting to devices in-range, receiving and/or transmitting data to connected devices, providing user setting such as a “wake” word, manual toggling of the device and system between active and “sleep” or non-active states, etc. The application may allow the user to select a default language for their own speech or may auto-detect the user's speech. The application may allow the user to select a default language for other participants in the conversation, for instance certain languages or dialects in regions that they are currently traveling. The application may alternatively auto-detect the language of other participants. The application may use location services to detect a location of the user to auto-detect regional languages. The application may present the user with visual information such as battery life of connected devices including the communication device, text of translated discussions in the user's written language for real-time viewing or for archiving and reference at a later date. The application may also provide volume controls, other voice modulations, selection of different voices for translation playback, and any other features related to real-time translation. The application may also contain automatic or manual conversational cadence features, such as increasing or decreasing a delay in playback of user or other participant translations in order to maintain a fluid conversation. The application may also allow for a training mode for training the device on a user's voice pattern and speech. Such a training mode may ask a user to speak certain words or phrases which capture the user's speech features in order to improve the accuracy of translations. A training mode may also be used for another individual or participant, for instance, if the user intends to hold a prolonged conversation with the other participant (for example, during a long meal or business meeting). These trained profiles may be stored for later access upon recognition or selection of each party in a conversation. It is possible that over time, the system will learn to recognize each party and optimize itself for their particular voice patterns and intonations. All of this information may be stored on the device, in the communications device or in the cloud. Any features may be automatically controlled, defaulted, or manually adjusted as advantageous or necessary.

The term “conversation” as used herein encompasses spoken communication between two individuals. One of the individuals is typically a user of a communication device while the other individual is a party with which the user is communicating.

The term “spoken words” as used herein encompasses speech, a verbal conversation, or any verbal interaction between a user and another individual or party.

The term “translating” as used herein generally refers to the translation of a user or individual's spoken words to another language, dialect, or regional variations of languages or, in cases of accent translation, to a corrected form of the same language. In all cases, any appropriate method of translation known to a skilled artisan is contemplated, including but not limited to, direct speech-to-speech translation, speech-to-text translation, artificial intelligence (AI)-based translation, machine learning (ML)-based translation, deep learning (DL)-based translation, etc.

The term “data signal” as used herein refers to a packet of information or data transmitted between or operated upon by communication, computing, and/or cloud-based computing devices. The “data signal” may be an audio file of a user's or individual's spoken words, a compressed file containing audio or having re-constructible audio, a text file or other file containing or encoding text converted from the spoken words, or any other appropriate packet of information which contains the user's or individual's spoken words.

The term “projecting”, such as in “projecting the translated speech” encompasses any necessary manipulations to the translated data signal necessary to play the translated data signal from a speaker. In some cases, this may include compression or de-compression, amplification, text-to-speech conversion, or any other necessary or desirable audio modulations. Such manipulations are not limited to a specific device and may be performed at any appropriate stage.

The term “outputting audio”, such as in “outputting audio of the translated speech” encompasses any necessary manipulations to the translated data signal necessary to play the translated data signal from a headphone or earbud speaker for the user to hear. In some cases, this may include compression or de-compression, amplification, text-to-speech conversion, or any other necessary or desirable audio modulations. Such manipulations are not limited to a specific device and may be performed at any appropriate stage.

The term “headphone speaker” as used herein encompasses any speaker which selectively provides audio to the ear(s) of the user, while minimizing any perceptible sound by another party. The headphone speaker may be wired or wirelessly connected to the communication device and/or wireless computing device. The headphone speaker includes earbuds, bone conduction headset, cochlear implant, on-ear headphone, over-ear headphone, oriented speaker toward user's ear(s), etc. Generally, any headphone speaker suitable for the systems and methods herein is contemplated.

In certain embodiments, one or more components of the communication device and/or wireless computing device may be separated from the user in the form of a terminal for use by another participant in the conversation. As an example, in another embodiment, a person behind a protective screen, such as a TSA Agent at the airport, might be connected via wireless to a tablet computer, on which the traveler might select a language of choice (or alternatively the language is auto-detected from the traveler's speech), and the tablet would translate the speech of the TSA Agent into that language, playing over the tablet or other external speaker. In such an embodiment, the TSA agent (i.e., the user) may be wearing a communication device including a microphone, and may be wearing a headphone or other local audio projection device for hearing the translation of the traveler's speech. The traveler's speech would be picked up by a microphone on the terminal and translations of the user's voice would be played over a speaker of the terminal. The terminal may also display translated text in the selected or detected language for the traveler to read, in addition to the verbal translation. In this manner, the traveler need not have any additional equipment or devices to have a fluid bidirectional conversation with the TSA agent.

### Accent Correction

A user may speak with a heavy accent or impediment, in which case other participants speaking the same language as the user may be unable to understand them. There exists a need for methods and systems which modulate the user's accented or impeded speech to allow others to understand them. Such methods and systems may be particularly useful in public-facing positions such as customer service.

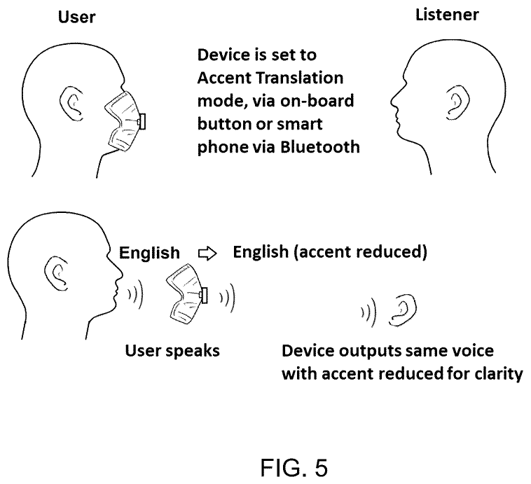

FIG. 5, as an example, shows real-time accent translation to allow for fluid communication with a listener. The user in the example is wearing a face mask with an attached communications device. For example, while accents may not significantly encumber conversations in some cases, heavy accents may make it difficult to communicate with other parties. Alternatively, it may be desirable to correct even minor accents for enhanced clarity in various situations. Especially in the case of the accented speaker wearing a mask, even slight accents can become more difficult to comprehend. A communication device may be set to translation mode by an on-board button or by an application running on a connected mobile computing device, such as via a Bluetooth connection. The output is the user's voice with a reduction in accent. Advantageously, the mask may prevent the listener from hearing the original speech clearly such that the listener may focus on the amplified, accent-corrected speech more easily. In various embodiments, the device may attach to the mask by magnetic attachments, a clip, or an adhesive attachment. The microphone may be located inside of the mask or on a portion of the communication device oriented toward the mask outer surface to pick up user speech.

In the course of an interaction between a user and a listener, once the communication device is set to accent translation mode, the user may speak in their accented voice. The application may have been manually set to the desired language or the language may be auto-detected. In one embodiment, a microphone of the communication device picks up the user's voice and sends the voice data to an onboard processing capability. In another embodiment, the voice data is sent to the wireless computing device. The communication device or wireless computing device either processes the voice data, and/or transmits the voice data to a cloud computer. In each instance, the user's voice is then modulated to correct pronunciation inaccuracies or other accent features which make their voice difficult to understand by a listener. If processed by the cloud, the corrected voice data is transmitted back to the wireless computing device, which in turn transmits the voice data to the communication device. The corrected voice data is then played back through a loudspeaker of the communication device for the listener to hear. The voice data may be one or more of an audio file, text generated from audio by the communication device, wireless computing device, or cloud computer, or any other usable format of voice data.

Face mask-worn devices present a particular advantage for real time accent translation because face masks further muffle voices, making accented or impeded voices even harder to understand. A system such as that which is shown in FIG. 1A is applicable to real-time translation with the omission of the earbud or headphone speaker, which is not required because translation of the listener's speech is not performed in this setting. Real-time accent translation also assists in avoiding significant public health risks because if an individual is having trouble being understood while wearing a mask, they may pull the mask down and increase their voice volume, thereby spreading potentially infective droplets to individuals in their proximity. Real-time accent translation therefore mitigates this risk for vital public-facing work environments.

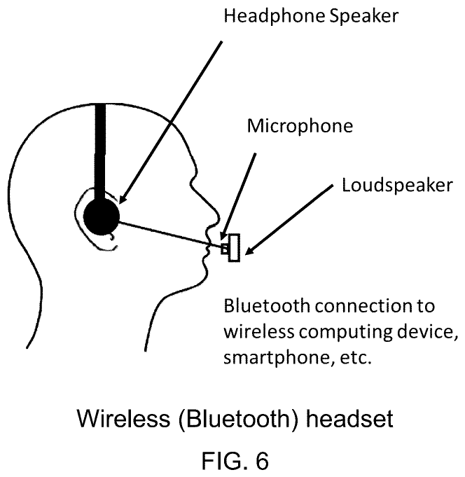

Headset-type devices, such as that of FIG. 6, may be used in place of mask-work devices. Such headset devices may be worn on top of a mask, or without a mask. While the headphone speaker is not required, it may be utilized to additionally play back the translated voice to the user so that they may directly hear the translation which was projected to the listener. In this manner, the user may carefully listen for any aspects of their speech which could be corrected or reiterated for better understanding by listeners.

### Communication Devices

An exemplary communication device is shown in FIG. 6, which is a headset-type communication device. The headset communication device differs from standard headsets because it has a loudspeaker oriented to project translated speech to another party. The headset also has a microphone to pick up speech from the user and a speaker positioned over the user's ear to play back translated speech from the other party. The device may have one or more additional microphones, such as a microphone positioned to pick up speech from the other party. Such an additional microphone may be incorporated in a position such that it is oriented away from the user. As shown in FIG. 1A, such a communication device may have at least one microphone, a speaker, a wireless circuit assembly, and a power source. Several additional components may be present in the communication device, such as a microprocessor or digital signal processor, flash memory, a data store for long-term or non-transitory data storage, audio amplifier, etc.

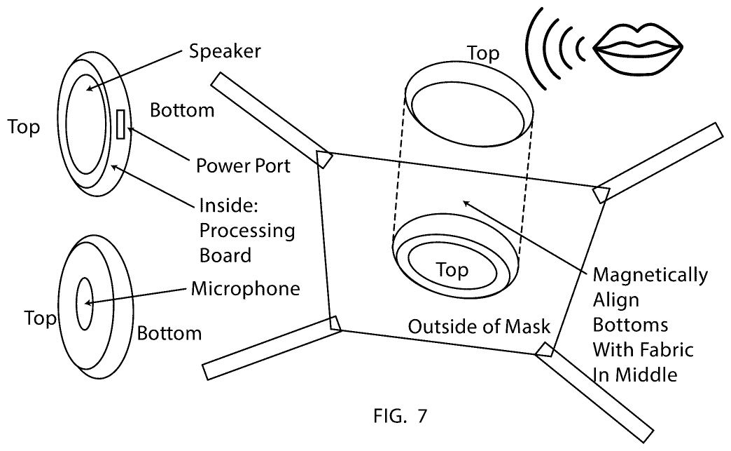

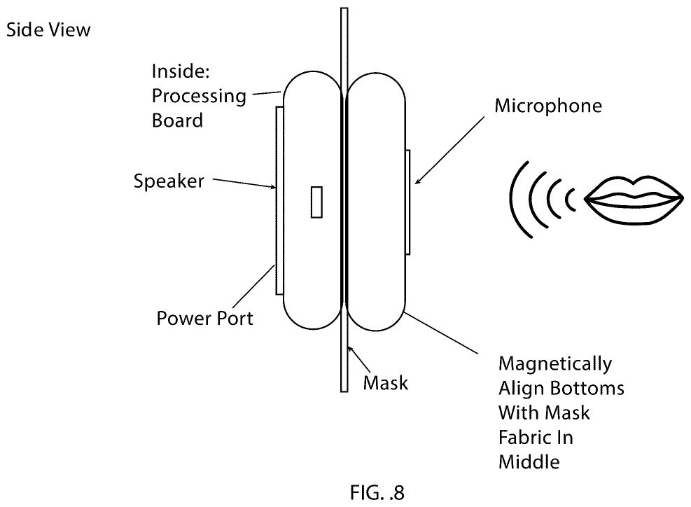

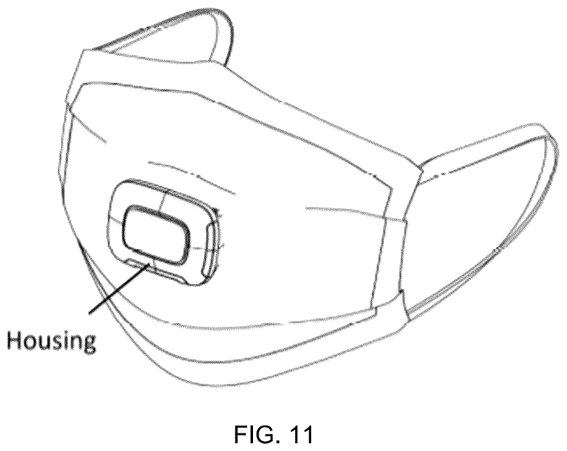

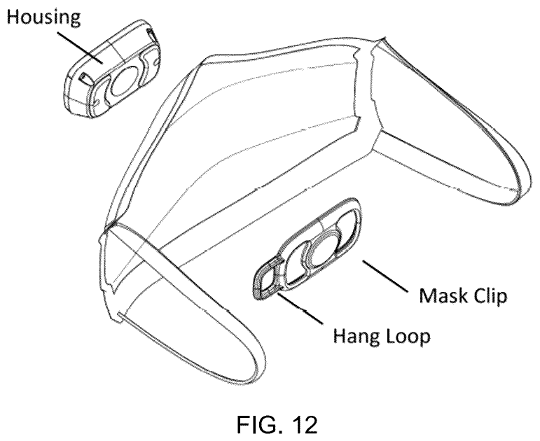

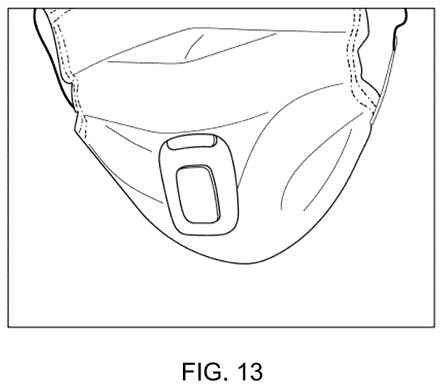

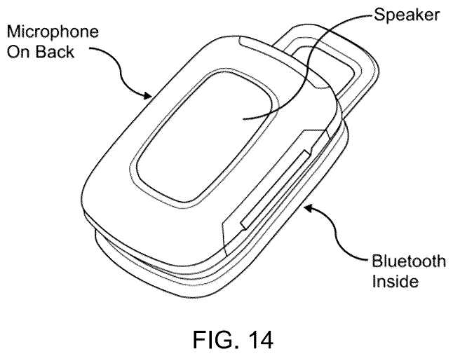

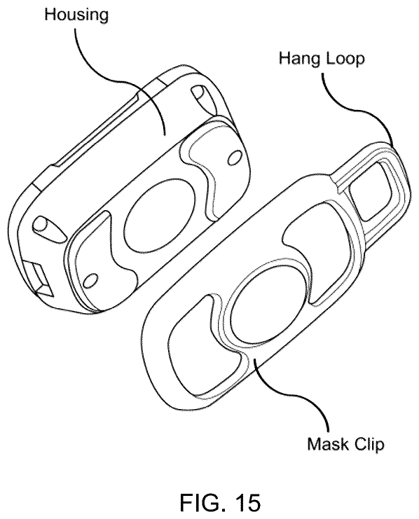

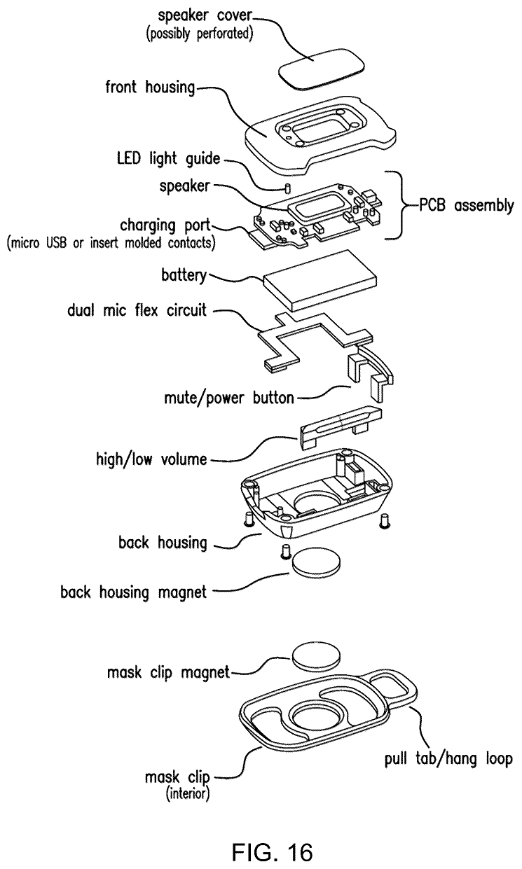

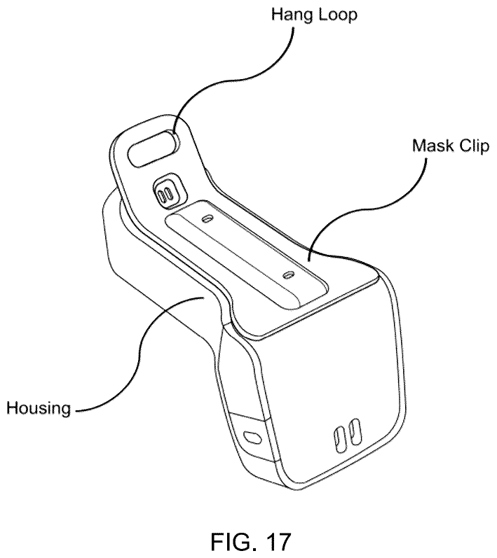

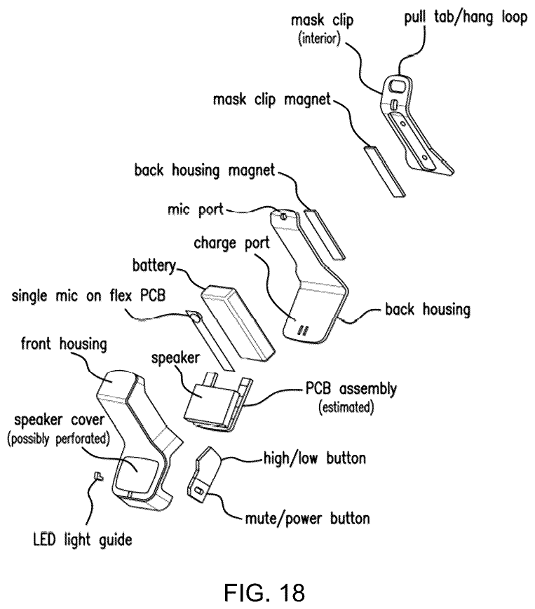

Exemplary communication devices for releasable magnetic attachment to face masks are depicted in FIGS. 7-18 and may include an additional forward-facing microphone for receiving the speech from a party other than the user. Additionally, all communication devices include a wireless circuit assembly capable to connecting wirelessly to a wireless computing device over any appropriate protocol, including Bluetooth. In alternative embodiments, the communication devices may communicate with a wireless headphone worn by the user or, alternatively or additionally, communication devices may have a physical port for connection of a headphone device.

In some embodiments, the present methods and systems utilize a communication device for releasable magnetic securement to a flexible mask, the device having a microphone configured to receive speech from the mask wearer; a housing comprising a speaker configured to broadcast the speech from the mask wearer; and a first magnetic attachment component and a complementary second magnetic attachment component to magnetically secure the housing to the flexible mask; wherein the first magnetic attachment component is associated with a back of the housing and the complementary second magnetic attachment component is arranged to produce an attractive force to the first magnetic attachment component to releasably secure the back of the housing to the mask. The speaker may be in the same housing as the microphone, or the microphone and speaker may be in different housings. The speaker and microphone housings, if separate, may be connected by a wired or wireless connection. Alternatively, the speaker and microphone housings are not connected directly and are independently connected to a wireless computing device.

In further embodiments, the magnetic attachment components are each independently selected from the group consisting of a magnet, a ferromagnetic material, and a ferrimagnetic material.

In further embodiments, the devices may further have one or more of a power indicator; a printed circuit board (PCB) assembly including the speaker and/or microphone; a power source for supplying power to the device; and a device control element, wherein the device control element comprises at least one of a power control, a volume control, a mute control, and optionally a mode or language selector.

In some embodiments, a mask clip may be utilized and the first and second magnetic attachment components are arranged to produce an attractive force sufficient to couple the housing to the mask clip with a flexible mask interposed therebetween.

In some embodiments, the flexible mask is selected from the group consisting of a cloth mask, fabric mask, disposable mask, single-use mask, surgical mask, procedure mask, medical mask, dust mask, filter mask, oxygen mask, KN95 mask, N95 mask, surgical N95 mask, N99 mask, KN99 mask, N100 mask, KN100 mask, R95 mask, P95 mask, P100 mask, PM2.5 mask, FFP1 mask, FFP2 mask, FFP3 mask, a multilayered mask, mask with removable filter, a face covering, handkerchief, kerchief, veil, hood, bandana, mask with fitter, mask with brace, PAPR mask and combinations and layered arrangements thereof.

In some embodiments, the present methods and systems utilize a communication device for releasable magnetic securement to a flexible mask, the device having a microphone configured to receive speech from the mask wearer; a speaker configured to broadcast speech from the mask wearer; and a housing comprising the microphone and speaker, wherein the housing is substantially L-shaped to conform to a human chin when mounted to the flexible mask in an under-chin position, and/or wherein the device has a total weight sufficient for attachment of the device to a flexible mask, the total weight not exceeding about 50 grams.

In general, mask-worn communication devices may have a minimal weight to ensure that they can be supported on flexible masks. Mask-worn devices may have a weight from about 20 to about 100 grams, or from about 30 to about 60 grams. For example, mask-work devices may have a weight of about 20 grams, or about 30 grams, or about 40 grams, or about 50 grams, or about 60 grams, or about 70 grams, or about 80 grams, or about 90 grams, or about 100 grams. In some embodiments, the mask-worn communication device can weigh more than 100 grams if the mask permits. Certain devices may have only a wired or wireless microphone which attaches to the mask, and the mask-supported microphone may have a weight of less than about 10 grams, or less than about 20 grams.

In some embodiments, the device further comprises a mask clip for engaging the housing, wherein at least one of the mask clip and the housing comprises a stabilizing protrusion for mating with an opening on the other and wherein the housing and mask clip when in an engaged state with the flexible mask interposed therebetween engage with sufficient force to cause the flexible mask to conform to the engaged stabilizing protrusion and opening.

In some embodiments, the device further comprises a first magnetic attachment component associated with a back of the housing and a second magnetic attachment component associated with the mask clip; wherein at least one of the first and second magnetic attachment components is a magnet and the first and second magnetic attachment components are arranged to produce an attractive force sufficient to couple the back of the housing to the mask clip with the flexible mask interposed therebetween; and wherein the magnetic attachment components are selected from the group consisting of a magnet, a ferromagnetic material, and a ferrimagnetic material.

In further embodiments, the device further comprises a power indicator; a printed circuit board (PCB) assembly including the speaker and/or microphone; a power source for supplying power to the device; and a device control element, wherein the device control element comprises at least one of a power control, a volume control, and a mute control.

In some embodiments, the device has a total weight sufficient for attachment of the device to a flexible mask for a period of at least about 30 minutes.

In further embodiments, the present methods and systems utilize a communication device for releasable magnetic securement to a flexible mask, the device having a housing comprising a microphone configured to receive speech from the mask wearer; a first magnetic attachment component and a complementary second magnetic attachment component to magnetically secure the housing to the flexible mask; and a speaker configured to broadcast the speech from the mask wearer; wherein the first magnetic attachment component is associated with a back of the housing and the complementary second magnetic attachment component is arranged to produce an attractive force to the first magnetic attachment component to releasably secure the back of the housing to the mask. The speaker may be in the same housing as the microphone, or the microphone and speaker may be in different housings. The speaker and microphone housings, if separate, may be connected by a wired or wireless connection. Alternatively, the speaker and microphone housings are not connected directly and are independently connected to a wireless computing device.

In some embodiments, the speaker is contained within a speaker module, the speaker module further comprising one or more of a power indicator; a printed circuit board (PCB) assembly including the speaker; a power source for supplying power to the device and one or more components thereof; and a device control element, wherein the device control element comprises at least one of a power control, a volume control, a mute control, and optionally a mode or language selector.

In some embodiments, the magnetic attachment components are each independently selected from the group consisting of a magnet, a ferromagnetic material, and a ferrimagnetic material.

In some embodiments, the microphone is in wired communication with the speaker module.

In some embodiments, the microphone is operatively connected to the speaker such that the speech received from the mask wearer is amplified and broadcast through the speaker.

In some embodiments, the microphone is operatively connected to the speaker through one or more of a microphone pre-amplifier, an equalization component, a sound output component, and an amplifier.

In some embodiments, the device further has within the speaker module, a circuit assembly comprising a wireless receiver and/or transmitter, wherein the microphone is in wireless communication with the housing.

In some embodiments, the first and second magnetic attachment components are arranged to produce an attractive force sufficient to couple the microphone to the mask clip with a flexible mask interposed therebetween.

In some embodiments, the flexible mask is selected from the group consisting of a cloth mask, fabric mask, disposable mask, single-use mask, surgical mask, procedure mask, medical mask, dust mask, filter mask, oxygen mask, KN95 mask, N95 mask, surgical N95 mask, N99 mask, KN99 mask, N100 mask, KN100 mask, R95 mask, P95 mask, P100 mask, PM2.5 mask, FFP1 mask, FFP2 mask, FFP3 mask, a multilayered mask, mask with removable filter, a face covering, handkerchief, kerchief, veil, hood, bandana, mask with fitter, mask with brace, a PAPR mask, and combinations and layered arrangements thereof.

In some embodiments, each of the magnetic attachment components are defined by complementary shapes with open centers selected from the group consisting of rings or squares.

In exemplary embodiments, the microphone is a noise-cancelling microphone. In further embodiments, the microphone includes or is associated with at least one noise filter. In further exemplary embodiments, one or more of the microphone, speaker and communications device is in a wireless configuration.

In further exemplary embodiments, an on-board speaker is integrated into a portion of the communications device. In further exemplary embodiments, a speaker is external to the communications device.

In additional exemplary embodiments, the communications device includes one or more integrated and/or coupler adapted noise cancelling microphones with wireless, e.g., Bluetooth®, capability. In further exemplary embodiments, the microphone signal is processed utilizing noise-cancelling sound processing. In exemplary embodiments, the microphone is attached to or built into face mask. In other embodiments, the microphone is a throat microphone, bone conduction microphone, or head-worn microphone.

In further exemplary embodiments, the microphone is configured to wirelessly transmit a patient's voice, via Bluetooth® technology, to a Bluetooth® speaker in proximity to and in communication with the Bluetooth® transmitter. In further exemplary embodiments, the microphone is configured to wirelessly transmit a patient's voice, via Bluetooth® technology, to a Bluetooth®-enabled smartphone in proximity to and in communication with the Bluetooth® speaker and/or the Bluetooth® transmitter. While a Bluetooth® speaker and an exemplary Bluetooth® smartphone are specifically described, the present disclosure contemplates other Bluetooth® communications devices. And while Bluetooth® is specifically described, the present disclosure contemplates other wireless technologies, including but not limited to Wi-Fi.

In additional exemplary embodiments is a communication device for releasable securement to a flexible mask, the device comprising: a microphone configured to receive speech from the mask wearer; a speaker configured to broadcast speech from the mask wearer; a power indicator [such as an LED power indicator or lighted indicator]; a printed circuit board (PCB) assembly including the speaker; a power source for supplying power to the device; a device control element; a housing optionally comprising a front housing component and a back housing component, and wherein the front and back housing components are configured to engage with each other to hold one or more of the microphone, the speaker, the power indicator, the PCB assembly, the power source, and the device control element; a first magnetic attachment component associated with the back housing; a mask clip for mating with the back housing component; and a second magnetic attachment component associated with the mask clip; wherein at least one of the first and second magnetic attachment components is a magnet and the first and second magnetic attachment components are arranged to produce an attractive force and to engage the back housing component with the mask clip. In these exemplary embodiments, the flexible mask is interposed between the back housing component of the housing and the mask clip.

In additional exemplary embodiment the power source can be a rechargeable power source.

In additional exemplary embodiments of the device, the magnetic attachment components are selected from the group consisting of a magnet, a ferromagnetic material, and a ferrimagnetic material.

In additional exemplary embodiments the mask clip comprises a hang loop at one end. The hang loop can be used for holding or positioning the device and for hanging it to a wearer's clothing when not in use.

In additional exemplary embodiments the device control element comprises at least one of a power control, a volume control, a mute control, and optionally a mode or language selector.

In additional exemplary embodiments the device further comprises a mask clip for engaging the back housing component, wherein at least one of the mask clip and the back housing component comprises a stabilizing protrusion for mating with an opening on the other, and wherein the back housing and mask clip when in an engaged state with the flexible mask interposed therebetween, engage with sufficient force to cause the flexible mask to conform to the stabilizing protrusion and the opening

In additional exemplary embodiments the microphone comprises two microphones and the two microphones are spaced apart from the speaker at a distance to minimize feedback.

In additional exemplary embodiments is a communication device for releasable securement to a flexible mask, the device comprising: a microphone configured to receive speech from a wearer of the flexible mask; a speaker configured to broadcast the speech received by the microphone; a power source for supplying power to the device; a housing comprising a front housing component and a back housing component, wherein the front and back housing components are configured to engage with each other to hold the microphone, the speaker, and the power source; a mask clip releasably securable to the housing; a first magnetic attachment component associated with the back housing component; and a second magnetic attachment component associated with the mask clip; wherein the first and second magnetic attachment components are arranged to produce an attractive force sufficient to couple the housing to the mask clip with the flexible mask interposed therebetween. Furthermore, the magnetic attachment components can be selected from the group consisting of a magnet, a ferromagnetic material, and a ferrimagnetic material.

In additional exemplary embodiments the device further comprises a control element for controlling at least one of power and volume. Furthermore the control element can also mute the device, and can optionally select between different device modes (i.e. language translation, accent translation, etc.) and languages.

In additional exemplary embodiments the microphone comprises a plurality of microphones and each of the microphones is spaced apart from the speaker at a distance to minimize feedback.

In additional exemplary embodiments the device further comprises a circuit assembly comprising a wireless transmitter.

In additional exemplary embodiments the wireless transmitter is a Bluetooth transmitter. Although a Bluetooth transmitter can be employed any other type of transmitter that performs a similar function can be used.

In additional exemplary embodiments the microphone and speaker are disposed on a same side of the flexible mask.

In additional exemplary embodiments the mask clip is configured for positioning on the inside of the flexible mask.

In additional exemplary embodiments the device is of a size and weight sufficient for attachment to the flexible mask until removed from the mask.

In additional exemplary embodiments the device is of a size and weight sufficient for attachment to the flexible mask for a period of at least 30 minutes. However, the device should be of a size and weight so that it is comfortable for the user, such that it can be attached to the flexible mask for as long as a user may want to have it attached. The size and weight of the device should be such so that it can be attached without a concern for removal because of discomfort to the user or distortion of the mask, which could impede the performance of the mask.

In additional exemplary embodiments the device has a length of from about 40 mm to about 60 mm, a width of about 20 mm to about 40 mm, and a depth of about 20 mm to about 40 mm. In additional exemplary embodiments the device has a length of about 50 mm, a width of about 30 mm, and a depth of about 30 mm.

In additional exemplary embodiments is an under-chin [L-shaped] mountable device for communicating with a mask wearer, the device comprising: a microphone configured to receive speech from the mask wearer; a speaker configured to broadcast speech from the mask wearer; a power indicator; a charging port; a rechargeable power source for supplying power to the device; a substantially L-shaped housing configured to conform to a human chin, the housing comprising a front housing component and a back housing component, wherein the back housing component comprises a microphone opening for permitting speech to reach the microphone, and wherein the front and back housing components are configured to be connected to hold the microphone, the speaker, the power indicator, and the rechargeable power source; and wherein the device has a total weight sufficient for attachment of the device to a flexible mask for a period of at least about 30 minutes, more preferably at least about 60 minutes.

In additional exemplary embodiments the L-shaped under chin device further comprises a mask clip for engaging the housing, wherein at least one of the mask clip and the housing comprises a stabilizing protrusion for mating with an opening on the other and wherein the housing and mask clip when in an engaged state with the flexible mask interposed therebetween engage with sufficient force to cause the flexible mask to conform to the engaged stabilizing protrusion and opening.

In additional exemplary embodiments the L-shaped under chin device further comprises a first magnetic attachment component associated with the back housing component and a second magnetic attachment component associated with the mask clip; wherein at least one of the first and second magnetic attachment components is a magnet and the first and second magnetic attachment components are arranged to produce an attractive force and to engage the back housing with the mask clip. In these exemplary embodiments, the flexible mask is interposed between the housing and the mask clip. Furthermore, the magnetic attachment components can be selected from the group consisting of a magnet, a ferromagnetic material, and a ferrimagnetic material. In additional exemplary embodiments the L-shaped under chin device controls

comprise of at least one of a power control, a volume control, and a mute control, and optionally a mode or language selector.

In additional exemplary embodiments is a system for communicating with a flexible mask wearer, the system comprising: a flexible mask; and a communications device; the communications device comprising: a microphone configured to receive speech from a wearer of the flexible mask; a speaker configured to broadcast the speech received by the microphone; a power source for supplying power to the device; a housing comprising a front housing component and a back housing component, wherein the front and back housing components are configured to engage with each other to hold the microphone, the speaker, and the power source; a mask clip releasably securable to the housing; a first magnetic attachment component associated with the back housing component; and a second magnetic attachment component associated with the mask clip; wherein the first and second magnetic attachment components are arranged to produce an attractive force sufficient to couple the housing to the mask clip with the flexible mask interposed therebetween. Furthermore, the magnetic attachment components can be selected from the group consisting of a magnet, a ferromagnetic material, and a ferrimagnetic material.

In additional exemplary embodiments of the system the device further comprises a circuit assembly comprising a wireless transmitter.

In additional exemplary embodiments the system further comprises a portable mobile communications device.

In additional exemplary embodiments the mask is selected from the group consisting of a cloth mask, fabric mask, disposable mask, single-use mask, surgical mask, procedure mask, medical mask, plastic mask, dust mask, filter mask, respirator mask, respiratory mask, oxygen mask, KN95 mask, N95 mask, surgical N95 mask, N99 mask, KN99 mask, N100 mask, KN100 mask, R95 mask, P95 mask, P100 mask, PM2.5 mask, FFP1 mask, FFP2 mask, FFP3 mask, a CPAP mask, a BiPAP mask, multilayered mask, mask with removable filter, a face covering, handkerchief, kerchief, veil, hood, bandana, mask with fitter, mask with brace, PAPR mask and combinations and layered arrangements thereof.

In additional embodiments, the system can be packaged and marketed as a kit comprising one or more masks in conjunction with a device of the present invention.

In additional embodiments, the present invention is also directed to facilitating communication using any of the devices disclosed herein.

The above-discussed and other features and advantages of the present invention will be appreciated and understood by those skilled in the art from the following detailed description and drawings.

In an embodiment, the device may be a communications device dimensioned and configured to be used with a mask, or other device that is intended to cover a user's face, nose, mouth and/or head. Commonly used face masks make communication more difficult by lowering and muffling a user's voice. Wearing masks may reduce inherent effectiveness of the mask by requiring mask wearers to stand closer together, shout, or remove the mask to adequately communicate. The disclosed communication device when combined with a mask, allows disposable or reusable masks to improve the user's communication from a safe distance as well as when using a phone or other communication device.

In an embodiment, particular communication devices may provide distinct advantages for users wearing a mask. For example, a device according to FIG. 9 may be used in systems and methods of real-time translation as described herein. A communication device may contain a microphone module in a first module or housing and a loudspeaker in a second module or housing. The first and second housing may be connected by a wired connection. The first housing may be releasably attachable to a mask and the second housing may be releasably attachable to a shirt, lapel, or torso of a user. The second housing may contain a second microphone for picking up speech of another individual other than the user. This arrangement is particularly advantageous because the lightweight and unencumbering first housing on the mask is positioned to selectively pick up speech from the user, while the second housing is located below the head of the user. This location ensures that a second microphone will be located distal from the user's mouth so as to avoid picking up speech, breathing, or other sounds of the user. Additionally, the second housing may contain other device circuitry such as one or more of: a wireless communication chip, power source, processor, data store, flash memory, buttons, physical data or power port(s), audio port or headphone jack, on/off switch, digital signal processing components, etc. In an embodiment of FIG. 9, the microphone module (i.e. the first housing) is releasably securable to a mask by a first magnetic attachment component associated with a back of the first housing and a second magnetic attachment component. The second magnetic attachment component may be associated with a “mask clip” or other structure inserted inside of the mask such that the magnetic attraction between the first magnetic attachment component and second magnetic attachment component sandwiches the mask material to retain the first housing in position on the mask, which is in turn positioned on the user's face. In alternative embodiments, the mask contains adhered or built-in magnetic attachment components for attachment to the first magnetic attachment component of the microphone module. In an embodiment, one of the magnetic attachment components is a magnet and the other is a magnet or a metal or other ferroelectric or ferrielectric material. In alternative embodiments, the speaker module (second housing) may contain similar magnetic attachment components, or a spring clip, a belt, strap, or any other feature to retain the second housing on the torso of the user or clothing on the torso of the user. Such advantageous devices of FIG. 9 and related embodiments may be useful in the systems and methods described herein.

A mask may be made of cloth, paper, cardboard, plastic, or other material. The mask may be used to conceal a user's identity, prevent the dissemination of the user's breath or expelled gases, liquids, or particulates. The mask may also protect the user from inhaling, or receiving on the face, other gases, liquids, or other particulates. Examples of masks include those selected from the group consisting of a cloth mask, fabric mask, disposable mask, single-use mask, surgical mask, procedure mask, medical mask, plastic mask, dust mask, filter mask, respirator mask, respiratory mask, oxygen mask, KN95 mask, N95 mask, surgical N95 mask, N99 mask, KN99 mask, N100 mask, KN100 mask, R95 mask, P95 mask, P100 mask, PM2.5 mask, FFP1 mask, FFP2 mask, FFP3 mask, a CPAP mask, a BiPAP mask, multilayered mask, mask with removable filter, a face covering, handkerchief, kerchief, veil, hood, bandana, mask with fitter, mask with brace, PAPR mask and combinations and layered arrangements thereof.

The communication device may be removably attachable to a disposable or reusable mask, which is particularly helpful to medical professionals, patients, first responders, or anyone who desires to cover their nose and mouth and/or filter the air they breathe or expel. The communication device may be reusable so that it may be removed from a first mask to subsequent masks. In an embodiment the communication device may be modular with multiple parts allowing it to attach to a mask. The communication device may include inner and outer housings, or just one inner or one outer housing. The communication device may be autoclavable or sterilizable, or disposable. In order to connect the communication device to the face mask, the device may include a mechanical clip, a spring, magnets, pins, hook and loop, snaps, buttons, glue or other adhesives, zippers, stitches, strings, ties, staples, suction, or other connective means. Certain features (e.g., snaps, buttons, zippers, cutouts fitting over mask ear loops, cutouts allowing mask ear loops through) may be complementary to features on the mask.

The inner and outer housings of the communication device may each include all other necessary components for successful operation of the communication device. The housings may be constructed of any reasonable material for commercial, personal, or medical devices, such as plastics, metals, woods, or man-made or natural materials. Each housing may also include elements to secure the inner and outer housings to the mask, and to create a connection between the inner and outer housings. In order to connect the inner and outer housings to the mask, the inner and outer housings may include a mechanical clip, a spring, a magnet, pins, hook and loop, snaps, buttons, glue or other adhesives, zippers, stitches, strings, ties, staples, suction, or other connective means. Certain features (e.g., snaps, buttons, zippers, cutouts fitting over mask ear loops, cutouts allowing mask ear loops through) may be complementary to features on the mask. The housings may be configured to slip into and reside in a pocket or other means for securement on the mask. The inner the outer housing may be configured to attach to eyeglasses, a hat, or other wearable item which allows the inner housing to be in close proximity to the user's mouth or nose.

The inner and outer housings may each include complementary magnetic attachments which allow the inner and outer housing to attach to one another, separated by the mask. Magnetic attachments create a secure and movable connection on the mask. The magnetic attachments may be a ring on each housing, which creates a secure connection between the inner and outer housing, and securely attaches the communication device to the mask. The complementary magnetic attachments pair to one another across the mask, yet still allow electrical signals to pass between the inner and outer housing. The complementary magnetic attachments may be a ring, or a square, or any other shape with an open center. The complementary magnetic attachments may also be a plurality of complementary magnetics on each of the inner and outer housings. The complementary magnetic attachments may have the ability to attach designs or otherwise showcase messages to the outer housing as a form of free speech or advertising.

The inner and outer elements may also be dimensioned in a curvilinear form, complementary to each other. The curvilinear form of the inner element may be placed inside the mask extending from one side to the other crossing the area in front of the user's mouth. A speaker may be located in a central location between the sides so that it is close to the user's mouth. Other features, such as electrical and attachment features, of the inner element may be located along the curvilinear form flanking the microphone. The curvilinear outer element may attach to the inner element by magnetic attachments at locations complementary to the inner element. In other embodiments, the elements may be part of, or attached to, an inner support frame/bracket that supports the form of the mask on the user's face.

The inner and outer housings may contain a power source. The power source may be in both housings, or the power source may be in only one of the housings. The power source may be a replaceable or rechargeable battery. Because of the close proximity of the housings, power may flow, via induction or other modalities, from the powered housing to the non-powered housing, through the mask. Alternatively, a physical connection, as described above, may span between the inner and outer elements to provide power to the non-powered element or exchange data between the elements. It is also contemplated that the device may mate with a mask having an existing port (for airflow, etc.) allowing a suitable path for a physical connection between the inner and outer elements.

One or both of the inner and outer housings may include a port and/or cable for a power source or power charging, or for data transfer. The port and/or cable may connect the housing, the element, and the device to another system for data or signal processing, charging, external speakers or communication, or any other relevant system.

The inner element may be located inside the mask in close proximity to the user's mouth, to easily pick up the user's voice. The inner element may act as or include a microphone and a transmitter. The inner element may transmit a signal, of the user's voice, to the outer element. The outer element may be releasably attachable to the outside of the mask. The outer element may include a transmitter, a receiver, and a speaker, to receive the signal from the inner element and then project the user's voice. The user's voice may be projected via the speaker in the outer housing or the inner or outer housings may also transmit the voice signal to an external speaker or system. The speaker in the outer housing may project the user's voice along or in combination with an external speaker or system. The microphone, speaker, and electrical processing may include any of the elements described above. The speaker may include a flared housing, such as a bull-horn to increase the user's voice. The transmission of signal between the inner element and the outer element may be wireless or may be via a physical connection between the elements. A wireless transmission between the inner and outer elements is suitable for a reusable mask or disposable mask. The transmission of electrical signal through the physical connection may include an element, extending from the inner or outer element, that pierces through a disposable mask and makes a physical and electrical connection with the other of the inner or outer element. This connection is suitable for a disposable mask or may be used with a reusable mask.

The communication device may also include sensors for detecting ambient or expelled gas mixtures or temperature. Monitoring gases, like air quality, and temperature may be helpful in respiratory therapy of patients, for first responders, or in any scenario where a user needs a mask. The device may include a separate membrane or filter used to sample or analyze, in real time, ambient or expelled air quality for contaminants, particulates, or pathogens. The membrane may be removable, replaceable, or cleanable. Sensors in the device may include a relative or absolute humidity sensor, a temperature sensor, a dew point sensor, an enthalpy sensor, a pressure sensor, a barometric sensor, a flow rate sensor, an oxygen sensor, a carbon monoxide or dioxide sensor, a nitrogen sensor, or a combination thereof. The sensors may detect or monitor characteristics not associated with air quality, these sensors may include acoustic sensors, light sensors, cameras, ambient temperature sensors, accelerometers, or any sensor pertinent to expelled or ambient environments. It is also contemplated that a sensor may be external to the device, but connects to a port on one or both of the inner or outer housings.

In operation, the device may detect a user's voice or sound via a microphone and reproduce that sound via a speaker. The device may include a microphone, a speaker, a processor, a battery (single use or rechargeable), a charging/data port, communications such as Bluetooth®, volume controls, lights, light-emitting displays (LEDs), a camera, a video screen, measuring ports with the ability to electronically measure breathing (and/or vapor exiting the user's mouth), noise, speech, tones, etc. The microphone may be noise canceling. The device may provide for communication between the inner and outer elements and any external system by any wired or wireless connection, such as RFID, WiFi, Bluetooth®, Zigbee, Zwave, 2G, 3G, 4G, 5G, or any reasonable later-developed wireless modality.

The device may also include a feedback unit for the user, such as a headphone or an in-ear component. The feedback unit may assist the user in hearing the user's voice. The feedback unit may also include an external microphone embedded in the outer element or connected to, but separate from, the outer element. The external speaker may transmit sound to the user's ear. The feedback unit may be dimensioned and configured to include additional microphones in other locations around the user, such as at the user's throat. The feedback unit may be useful for masks, helmets, or other item that covers or isolates the user's head.

It is contemplated that the device may include any other reasonable technology, system, or processes to assist in communication between a user and another. These technologies include microprocessors, microcontrollers, computer chips, programmable algorithms for processing the data of the device (including sound), any component for capturing sound and human voice, speakers and any technology used to project sound and human voice, noise cancellation technology, wireless capabilities for communication between the microphone and the speaker as well as between the device and remote devices such as external speakers, portable/cellular phones, watches, computers, and televisions. The device may include voice enhancing technology and voice recognition/voice regeneration technology as well as voice command technology as found in personal digital assistants like Amazon® Alexa®. The device may include machine learning and other programming code that will learn the voice of the user and optimize the system for that voice or regenerate voice in that user's voice. This voice may be increased in volume based on settings on the device and voice processing in the unit. This voice might be changed, such as via an electronic voice synthesizer or similar technology. The device may include hardware or software acoustic filters in the device that may screen out non-human voice range sounds.

The details of one or more embodiments of the invention are set forth herein. Although any materials and methods similar or equivalent to those described herein can be used in the practice or testing of the present invention, the preferred materials and methods are now described. Other features, objects and advantages of the invention will be apparent from the description. In the description, the singular forms also include the plural unless the context clearly dictates otherwise. Unless defined otherwise, all technical and scientific terms used herein have the same meaning as commonly understood by one of ordinary skill in the art to which this invention belongs. In the case of conflict, the present description will control.

### Equivalents and Scope

Those skilled in the art will recognize, or be able to ascertain using no more than routine experimentation, many equivalents to the specific embodiments in accordance with the invention described herein. The scope of the present invention is not intended to be limited to the above Description, but rather is as set forth in the appended claims.

In the claims, articles such as “a,” “an,” and “the” may mean one or more than one unless indicated to the contrary or otherwise evident from the context. Claims or descriptions that include “or” between one or more members of a group are considered satisfied if one, more than one, or all of the group members are present in, employed in, or otherwise relevant to a given product or process unless indicated to the contrary or otherwise evident from the context. The invention includes embodiments in which exactly one member of the group is present in, employed in, or otherwise relevant to a given product or process. The invention includes embodiments in which more than one, or the entire group members are present in, employed in, or otherwise relevant to a given product or process.

It is also noted that the term “comprising” is intended to be open and permits but does not require the inclusion of additional elements or steps. When the term “comprising” is used herein, the term “consisting of” is thus also encompassed and disclosed.

Where ranges are given, endpoints are included. Furthermore, it is to be understood that unless otherwise indicated or otherwise evident from the context and understanding of one of ordinary skill in the art, values that are expressed as ranges can assume any specific value or subrange within the stated ranges in different embodiments of the invention, to the tenth of the unit of the lower limit of the range, unless the context clearly dictates otherwise.

In addition, it is to be understood that any particular embodiment of the present invention that falls within the prior art may be explicitly excluded from any one or more of the claims. Since such embodiments are deemed to be known to one of ordinary skill in the art, they may be excluded even if the exclusion is not set forth explicitly herein. Any particular embodiment of the compositions of the invention (e.g., any antibiotic, therapeutic or active ingredient; any method of production; any method of use; etc.) can be excluded from any one or more claims, for any reason, whether or not related to the existence of prior art.

It is to be understood that the words which have been used are words of description rather than limitation, and that changes may be made within the purview of the appended claims without departing from the true scope and spirit of the invention in its broader aspects.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention.

What is claimed is:

1-25. (canceled)

26. A system for facilitating conversation between a user and another party, each speaking different languages, comprising:
a. a communication device worn by a user, the communication device comprising:
a first microphone to receive speech from the user in a first language spoken by the user;
a loudspeaker to project translated speech from the user to another party into a second language spoken by another party;
a second microphone to receive speech from another party in the second language;
a headphone speaker to project translated speech from another party to the user in the first language;
optionally, a digital signal processor;
a wireless circuit assembly; and
a power source;
b. a wireless computing device wirelessly linked to the communication device;
c. optionally, a cloud computer connected with the wireless computing device over the internet;
d. a translation program running on the communication device, wireless computing device, or cloud computer to translate spoken words of the user, in the first language, to the second language in real time and
e. optionally, language source code stored on one or more of the communication device, wireless computing device, or cloud computer.

27. The system of claim 26, wherein the translation program is an AI translation program.

28. The system of claim 26, further comprising a latency evaluation logic running on a processor of the wireless computing device or on a processor of the communication device.

29. The system of claim 28, wherein the latency evaluation logic determines the duration of time for the translated speech to be received by the wireless computing device.

30. The system of claim 29, further comprising a conversational cadence logic to adjust a timing at which the translated speech in the second language is projected.

31-37. (canceled)

38. The system of claim 26, further configured for real-time accent correction the translation program configured to correct an accent of speech by the user in the first language, wherein the system is configured to project accent-corrected speech in the first language from the loudspeaker.

39-47. (canceled)

48. A system for facilitating conversation between a user and another party, each speaking different languages, comprising:
a. a mask worn by the user;
b. a communication device releasably attachable to the mask, the communication device comprising:
a first microphone to receive speech from the user in a first language spoken by the user;
a loudspeaker to project translated speech from the user to another party into a second language spoken by another party;
a second microphone to receive speech from another party in the second language;
a headphone speaker to project translated speech from another party to the user in the first language;
optionally, a digital signal processor;
a wireless circuit assembly; and
a power source;
c. a wireless computing device wirelessly linked to the communication device;
d. optionally, a cloud computer connected with the wireless computing device over the internet;
e. a translation program running on the communication device, wireless computing device, or cloud computer to translate spoken words of the user, in the first language, to the second language in real time and
f. optionally, language source code stored on one or more of the communication device, wireless computing device, or cloud computer.

49. The system of claim 48, wherein at least the microphone is contained within a housing having a first magnetic attachment component associated with the housing.

50. The system of claim 49, wherein the mask comprises a second magnetic attachment component for releasable attachment with the first magnetic attachment component to secure the housing to the mask.

51. The system of claim 49, further comprising a second magnetic attachment component for placement inside of the mask to secure the housing to the mask with the mask interposed therebetween.

52. The system of claim 50, wherein the mask is a hood or respirator having a face lens, and wherein the second magnetic attachment component is molded into or permanently adhered to the lens.

53. The system of claim 52, wherein the hood is a PAPR hood.

54. The system of claim 48, wherein the first microphone is contained within a first housing and wherein the second microphone is contained within a second housing operably connected with the first housing.

55. The system of claim 48, wherein the first microphone is contained within a first housing and the speaker and second microphone are contained within a second housing operably connected with the first housing.

56. The system of claim 48, wherein the first microphone, second microphone, and speaker are contained within a housing and wherein the first microphone and second microphone are positioned at opposing portions of the housing.

57. The system of claim 54 wherein the first housing comprises a first magnetic attachment component associated with the back of the first housing to secure the back of the housing to the mask by with a second magnetic attachment component.

58. The system of claim 56, further comprising a first magnetic attachment component associated with a back of the housing and a second magnetic attachment component configured to releasably engage with the first magnetic attachment component to secure the housing to the mask with the mask interposed therebetween.

59. The system of claim 48, wherein the mask is selected from the group consisting of a cloth mask, fabric mask, disposable mask, single-use mask, surgical mask, procedure mask, medical mask, dust mask, filter mask, oxygen mask, KN95 mask, N95 mask, surgical N95 mask, N99 mask, KN99 mask, N100 mask, KN100 mask, R95 mask, P95 mask, P100 mask, PM2.5 mask, FFP1 mask, FFP2 mask, FFP3 mask, a multilayered mask, mask with removable filter, a face covering, handkerchief, kerchief, veil, hood, bandana, mask with fitter, mask with brace, PAPR mask and combinations and layered arrangements thereof.

60. The system of claim 48, wherein the translation program is an AI translation program.

61. A system for facilitating conversation between a masked user and another party, each speaking different languages, comprising:
a. a communication device worn by a user, the communication device comprising:
a first housing, the first housing comprising microphone to receive speech from the user in a first language spoken by the user, the first housing being releasably attachable to a mask work by the user;
a second housing comprising a loudspeaker to project translated speech from the user to another party into a second language spoken by another party;
a second microphone contained within the second housing to receive speech from another party in the second language;
a processor;
a wireless circuit assembly; and
a power source,
wherein the first housing includes a first magnetic attachment component associated with a back of the housing and a second magnetic attachment component securable to the first magnetic attachment component with the mask interposed therebetween to releasably secure the first housing to the mask, and
wherein the first and second housings are connected by a wired connection of a length sufficient to position the second housing on a torso of the user;
b. optionally, a wireless computing device wirelessly linked to the communication device;
c. optionally, a cloud computer connected with the wireless computing device over the internet;
d. a translation program running on the communication device, wireless computing device, or cloud computer to translate spoken words of the user, in the first language, to the second language in real time and
e. optionally, language source code stored on one or more of the communication device, wireless computing device, or cloud computer.
